(19) United States
(12) Patent Application Publication
(10) Pub. No.: US 2017/0228594 A1
(43) Pub. Date: Aug. 10, 2017

(54) IRIS AUTHENTICATION APPARATUS

(71) Applicant: FUJITSU LIMITED, Kawasaki-shi (JP)

(72) Inventor: Yuji Takemoto, Kawasaki (JP)

(73) Assignee: FUJITSU LIMITED, Kawasaki-shi (JP)

(21) Appl. No.: 15/419,374

(22) Filed: Jan. 30, 2017

(30) Foreign Application Priority Data
Feb. 5, 2016 (JP) 2016-020763
Oct. 4, 2016 (JP) 2016-196333

(51) Int. Cl. G06K 9/00; G06T 7/73; G06K 9/20; G06K 9/46

(52) U.S. Cl. CPC G06K 9/00617; G06K 9/00718; G06K 9/4671; G06T 7/74; G06K 9/4661; G06K 9/2027; G06K 9/0061; G06K 2009/4666

(57) ABSTRACT

An iris authentication apparatus includes a memory and a processor. The processor coupled to the memory. The processor is configured to perform acquiring video/still images becoming an iris authentication processing target, specifying an area range with an iris authentication processing target image being captured based on a front-and-rear positional relation about a plurality of images within the video/still images, and implementing iris authentication by detecting irises in the area range.

### CROSS-REFERENCE TO RELATED APPLICATIONS

This application is based upon and claims the benefit of priority of the prior Japanese Patent Application No. 2016-020763, filed on Feb. 5, 2016, and the Japanese Patent Application No. 2016-196333, filed on Oct. 4, 2016, the entire contents of which are incorporated herein by reference.

### FIELD

The present invention related to an iris authentication apparatus.

### BACKGROUND

On account of a rise of problem consciousness about a risk against a leakage of information, there is a tendency for an expansion of a field of utilizing biometric authentication of implementing authentication by using features and other equivalent characteristics of a human body of a target person. The features and other equivalent characteristics of the human body, which are used for the biometric authentication, can be exemplified by, a face, a fingerprint, a voiceprint, a handwriting, a vein, a retina, an iris (which is a doughnut-shaped region exclusive of a pupil, i.e., a dark-eyed region) of an eye as features inherent in an individual. The biometric authentication involves using the features and other equivalent characteristics of the human body of the target person for the authentication, and therefore enables avoidance of risks such as forgetting a password and missing an IC card. The biometric authentication also enables the avoidance of the risk such as erroneously authenticating a third person masquerading as a valid password holder or a valid IC card holder due to a leakage of the password and stealing the IC card.

In the features and other equivalent characteristics of the human body that are used for the biometric authentication described above, the iris of the eye is protected by an eyelid, a cornea and other equivalent regions and therefore has a characteristic of being hard to cause a change with an elapse of time. Hence, the iris authentication using features of an iris pattern for authenticating the individual is easy to ensure biometric authentication information having a long-term stability, and can attain the authentication that is high in accuracy but is low in misconception rate. Note that the iris pattern of the target person can be recognized based on video/still images captured by a camera and other equivalent image capture devices, and therefore enables the individual authentication in a non-contact state.

In recent years, there has been a tendency of introducing the iris authentication by way of an authentication tool in an entry control system and a tool for ensuring security of a portable electronic equipment. The portable electronic equipment can be instanced by an information processing apparatus equipped with a camera and other equivalent image capture devices, like a smartphone, a Personal Computer (PC), a notebook PC, a tablet PC, and a Personal Data Assistance (PDA). A person using the electronic equipment (who will hereinafter be also termed a user) can use the electronic equipment with its security being canceled after authenticating an identity of the user through, e.g., the iris authentication. Note that the following Patent Documents are given as Documents of Prior Arts describing technologies related to a technology that will be described in the present specification.

### DOCUMENTS OF PRIOR ARTS

### Patent Documents

[Patent Document 1] Japanese Patent Application Laid-Open Publication No. 2012-22713

[Patent Document 2] Japanese Patent Application Laid-Open Publication No. 2002-51255

### SUMMARY

The technology described above can be exemplified by an iris authentication apparatus that follows. The iris authentication apparatus includes a memory and a processor. The processor coupled with the memory. The processor executes acquiring video/still images becoming an iris authentication processing target, specifying an area range with an iris authentication processing target image being captured based on a front-and-rear positional relation about a plurality of images within the video/still images, and implementing iris authentication by detecting irises in the area range.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF THE DRAWINGS

FIG. 1 is an explanatory diagram of an iris authentication apparatus according to a present embodiment;

FIG. 2 is an explanatory diagram of the iris authentication apparatus according to the present embodiment;

FIG. 3 is an explanatory diagram of the iris authentication apparatus according to the present embodiment;

FIG. 4 is a diagram illustrating an example of a hardware configuration of the iris authentication apparatus according to the present embodiment.

FIG. 5 is an explanatory diagram of respective processing units of the iris authentication apparatus;

FIGS. 6A-6B are explanatory diagrams of video/still images captured by being illuminated with illumination light having different radiant intensities;

FIGS. 7A-7B are explanatory diagrams of segmentation into block areas based on luminance difference images;

FIG. 8 is an explanatory diagram of a luminance difference histogram;

FIG. 9 is a flowchart illustrating processes related to the iris authentication in an embodiment 1;

FIG. 10 is an explanatory diagram of processing blocks of the iris authentication apparatus in an embodiment 2;

FIG. 11 is a flowchart illustrating processes related to the iris authentication in the embodiment 2;

FIGS. 12A-12B are explanatory diagrams illustrating how an image capture position of a user is biased within the video/still images concomitantly with a change of the posture of the iris authentication apparatus;

FIGS. 13A-13B are explanatory diagrams illustrating how the image capture position of the user is biased within the video/still images concomitantly with the change of the posture of the iris authentication apparatus;

FIG. 14 is an explanatory diagram of processing blocks of the iris authentication apparatus according to an embodiment 3;

FIG. 15 is an explanatory diagram of processes related to detection of eyes in the embodiment 3; and

FIG. 16 is a flowchart illustrating processes related to the iris authentication in the embodiment 3.

### DESCRIPTION OF EMBODIMENTS

By the way, images of the iris patterns of the user are captured by the camera and other equivalent image capture devices when implementing the iris authentication by the electronic equipment described above. The user sets a face position confronting closely with an external wall surface provided with the camera and other equivalent image capture devices of the electronic equipment, thus causing the camera of the electronic equipment to recognize the iris patterns of the user. It is difficult to say that this operation of the electronic equipment to implement the iris authentication is of a natural posture, resulting in causing a misconception against other persons.

For example, such a case is assumed that the iris authentication is implemented by using the smartphone in a state of sitting on a seat and other equivalent sitting tools in a crowded place like a waiting room at a station and a lobby at an airport. The smartphone is operated to move such as being lifted for setting a camera position confronting with the front face of the user sitting thereon. It will be predicted that other persons positioned in a face-to-face relation with the sitting user have misconceptions of their images being seemingly captured without notice by the smartphone lifted by the moving operation.

For preventing the misconceptions caused use to the posture when implementing the authentication, e.g., it is considered to widen an angle of view of the camera capturing the images of the iris patterns. However, the widening of the angle of view of the camera that captures the images of the iris patterns and the enlarging of the image capture range possibly lead to a rise in image processing throughput. In the case of enlarging the image capture range, images of persons other than the user become easy to be unintentionally captured within the image capture range (within the angle of view) when implementing the iris authentication. When the images of the plurality of persons are unintentionally captured, the plurality of these persons becomes processing target persons for the iris authentication, resulting in an increase in processing load on the electronic equipment.

According to one aspect, the present invention aims at enabling iris authentication to be implemented in a natural operating posture, while restraining a rise in image processing throughput.

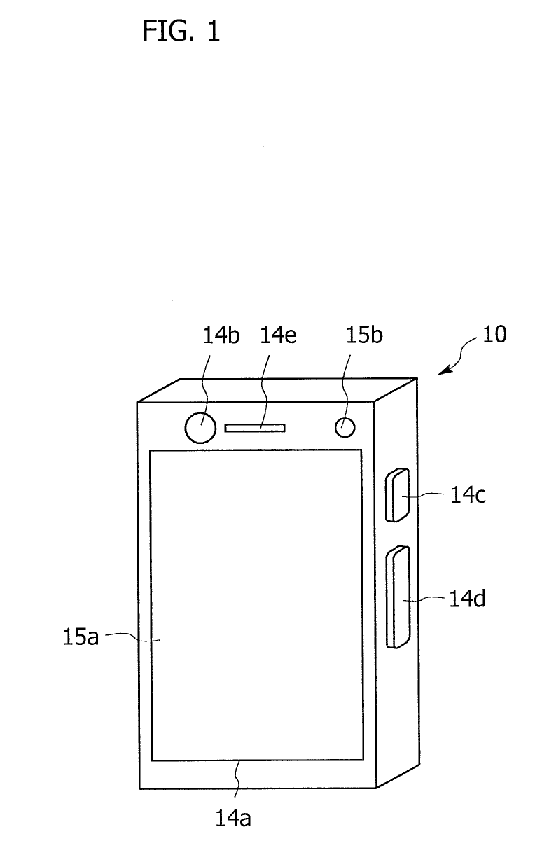

An iris authentication apparatus according to one embodiment will hereinafter be described with reference to the drawings. Configurations of the following embodiments are exemplifications, and the present iris authentication apparatus is not limited to the configurations of the embodiments that follow. The iris authentication apparatus will hereinafter be described based on the drawings of FIGS. 1 through 16.

### Embodiment 1

FIG. 1 illustrates an explanatory diagram of the iris authentication apparatus according to the embodiment 1. An iris authentication apparatus 10 in the embodiment 1 is a portable electronic equipment having an iris authentication function. The portable electronic equipment can be instanced by a smartphone, a tablet Personal Computer (PC), a notebook PC, a Personal Data Assistance (PDA), a game machine, and a digital camera. Note that the portable electronic equipment may also be a wearable electronic equipment, e.g., a digital audio player, a watch type electronic equipment or a wristband type electronic equipment, which are wearable to a body of a using person (who will hereinafter be simply termed a user).

The iris authentication is conducted based on a body feature inherent in the user, i.e., a feature of pattern of an iris (which is a doughnut-shaped region exclusive of a pupil, i.e., a dark-eyed region) of an eye. The feature of pattern of the iris (which will hereinafter simply be referred to as an iris pattern) can be recognized from video/still images captured by, e.g., a camera and other equivalent image capturing devices.

The iris authentication apparatus 10 detects a user's eye from the captured image captured by, e.g., the camera and other equivalent image capturing devices, and extracts the iris pattern of the detected eye. The extracted iris pattern is registered in a database (which will hereinafter be abbreviated to DB) by being associated with, e.g., identification information of the user. The iris authentication apparatus 10 retains the user's iris pattern as authentication information for unlocking a device for ensuring security. A phrase “unlocking the device for ensuring the security” will hereinafter be simply expressed by “cancelling the security”. Note that the iris patterns of the right and left eyes are registered as the authentication information respectively in the DB.

When authenticating the irises, for example, the iris authentication apparatus 10 checks the iris patterns acquired from the video/still images captured by the camera and other equivalent image capturing devices against the iris patterns registered in the DB. The iris authentication apparatus 10 implements checking against the iris patterns of the user's right and left eyes respectively, which are registered in the DB. When the iris patterns registered in the DB are coincident with the iris patterns captured by the camera and other equivalent image capturing devices, the iris authentication apparatus 10 cancels the security being set. After authenticating a user's identity based on, e.g., the iris authentication, the user is thereby enabled to use the iris authentication apparatus 10, of which the security is canceled.

Note that the iris of the eye has such a feature that the iris is protected by an eyelid and a cornea, and is therefore hard to cause a change with an elapse of time. It can be expected that there will be stably high sameness between the user's iris pattern registered as the authentication in the DB and the user's iris pattern captured by the camera and other equivalent image capturing devices on the occasion of the authentication. The iris authentication apparatus 10 may therefore authenticate the user's identity, e.g., on the condition that the user's iris pattern captured by the camera and other equivalent image capturing devices is coincident with the iris pattern of any one of the right and left eyes, which is registered as the authentication information in the DB.

Whereas when the iris pattern registered in the DB is not coincident with the iris pattern captured by the camera and other equivalent image capturing devices, the iris authentication apparatus 10 does not cancel the security. The iris authentication apparatus 10 with the security not being canceled continues in, e.g., a locked status. In the iris authentication apparatus 10 continuing in the locked status, for example, a display device continues in a lights-off status and is therefore disabled from accepting an operation input of an operation button and other equivalent units. The iris authentication apparatus 10 is enabled to prevent a leakage of information and other equivalent data to the third person having the iris patterns not coincident with the iris patterns registered in the DB.

The iris authentication apparatus 10 illustrated in FIG. 1 is the portable electronic equipment instanced specifically by the smartphone. As illustrated in FIG. 1, the iris authentication apparatus 10 in the embodiment 1 includes an iris capture camera 14b for capturing an image of the iris pattern. The iris authentication apparatus 10 further includes an illumination unit 15b that illuminates an authentication process target person with visible light and infrared light when capturing the image of the iris pattern. The iris authentication apparatus 10 captures an image of the target person illuminated with illumination light emitted from the illumination unit 15b by using the iris capture camera 14b. The iris authentication apparatus 10 acquires the iris pattern of the user becoming the iris authentication process target person from the video/still images captured by the iris capture camera 14b.

Note that the iris authentication apparatus 10 depicted in FIG. 1 includes input buttons, i.e., a power button 14c and an operation button 14d for accepting instructions of user's operations. The iris authentication apparatus 10 performing as the smartphone includes a speech receiver 14e configured by combining an output device instanced by a loudspeaker with an input device instanced by a microphone. The iris authentication apparatus 10 connects to an unillustrated wireless network instanced by a mobile phone network, and performs a voice-to-voice speech with other electronic equipments having communication functions connected to the wireless network via the speech receiver 14e.

The iris authentication apparatus 10 illustrated in FIG. 1 includes the display device instanced by a Liquid Crystal Display (LCD) 15a. A display screen of the LCD 15a is provided on an external wall surface formed with an aperture of the iris capture camera 14b and an aperture of the illumination unit 15b, which are mounted in the iris authentication apparatus 10. Various items of data and other equivalent information, which are processed by a Central Processing Unit (CPU) 11 of the iris authentication apparatus 10, are displayed on the LCD 15a. Note that the display device instanced by the LCD 15a may also be a panel, e.g., a touch panel configured in combination with a touch sensor 14. The touch panel detects a contact position of a user's manipulating finger that contacts a sensor surface of the touch sensor 14a. The touch sensor 14a is thus provided, and the iris authentication apparatus 10 is enabled to accept an input of the user's operation using the manipulating finger that contacts the sensor surface.

The iris capture camera 14b is a camera having an image capture element instanced by a Complementary Metal-Oxide-Semiconductor (CMOS) and a Charge Coupled Device (CCD). The iris capture camera 14b has an image capture range that is wide-angled at 80 or more degrees in up-and-down directions and right-and-left directions. The iris capture camera 14b has resolutions that is capable of capturing the image of the iris pattern defined as a feature of the iris pattern of the eye. The resolutions of the iris capture camera 14b can be exemplified by 10 pix/mm-15 pix/mm. The iris capture camera 14b captures the video/still images at a frame rate instanced by 30 Frames Per Second (FPS).

The iris authentication apparatus 10 in the embodiment 1 has the image capture range wide-angled at 80 or more degrees in the up-and-down directions the right-and-left directions, and is thereby enabled to relatively expand the image capture range for capturing the image of the iris pattern. The iris capture camera 14b can capture the image of the iris pattern of the user with the iris authentication apparatus 10 placed on, e.g., knees in a posture of sitting on a chair and other equivalent pieces of furniture.

The iris authentication apparatus 10 including the wide-angle iris capture camera 14b enables the operation of authenticating the iris in such a natural posture as to adjust a line of sight to the surface of the display device, i.e., the LCD 15a in a state of being placed on the knees. On the other hand, it is feasible to restrain the user from moving and lifting the iris authentication apparatus 10 up to a user′ face so that the camera is set in a correct position with respect to a face front. As a result of the above, the iris authentication apparatus 10 enables the user performing the iris authentication to avoid such misunderstandings of other persons around the user that the user might perform unauthorized photographing.

Note that it does not mean that an angle-of-view range of the iris capture camera 14b is limited to the image capture range angled at 80 or more degrees in the up-and-down directions and the right-and-left directions. As stated above, it may be sufficient that the angle-of-view range of the iris capture camera 14b is an angle-of-view range enabling the camera to capture the image of the iris pattern of the iris authentication target person.

The infrared light is used as the illumination light illuminated from the illumination unit 15b, in which case the iris capture camera 14b can be configured as an infrared camera capable of capturing the images by the infrared light. The visible light is employed as the illumination light illuminated from the illumination unit 15b, in which case the iris capture camera 14b can be configured as a camera for a general-purpose photography, which is mounted in the smartphone and other equivalent equipments. Note that the iris capture camera 14b may also be an infrared camera configured by fitting a visible light filter and other equivalent filters to the camera for the general-purpose photography, which is mounted in the smartphone and other equivalent equipments.

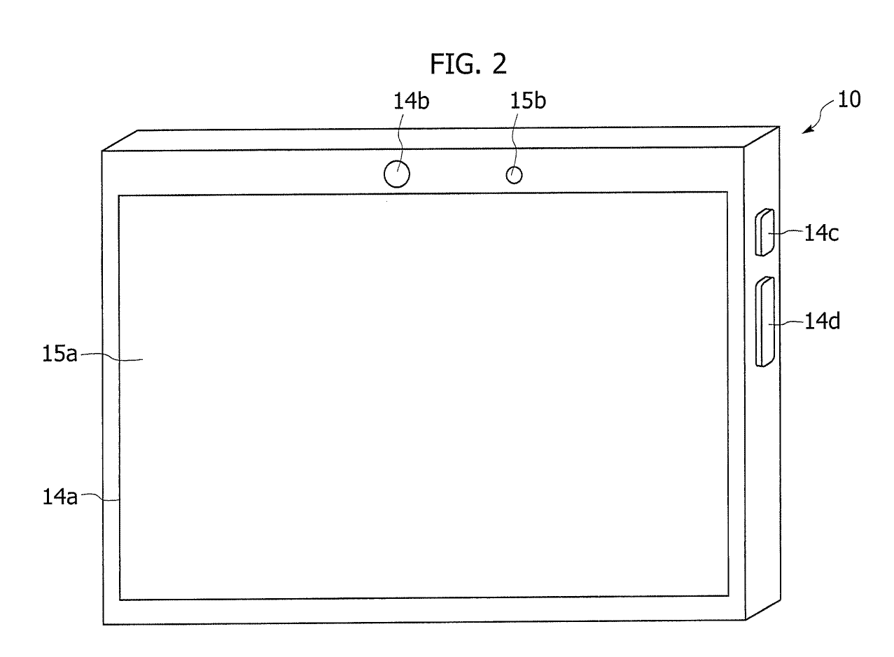

FIG. 2 illustrates one example of the tablet PC by way of another mode of the iris authentication apparatus 10. The iris authentication apparatus 10 includes the iris capture camera 14b and the illumination unit 15b also in the mode of the tablet PC similarly to FIG. 1. As depicted in FIG. 2, the iris authentication apparatus 10 based on the tablet PC includes the input buttons instanced by the power button 14c and the operation button 14d, and the display device instanced by the LCD 15a. The display device instanced by the LCD 15a functions as a pointing device of the iris authentication apparatus 10 by being combined with the touch sensor 14a for detecting the contact position of the user's manipulating finger that contacts the sensor surface.

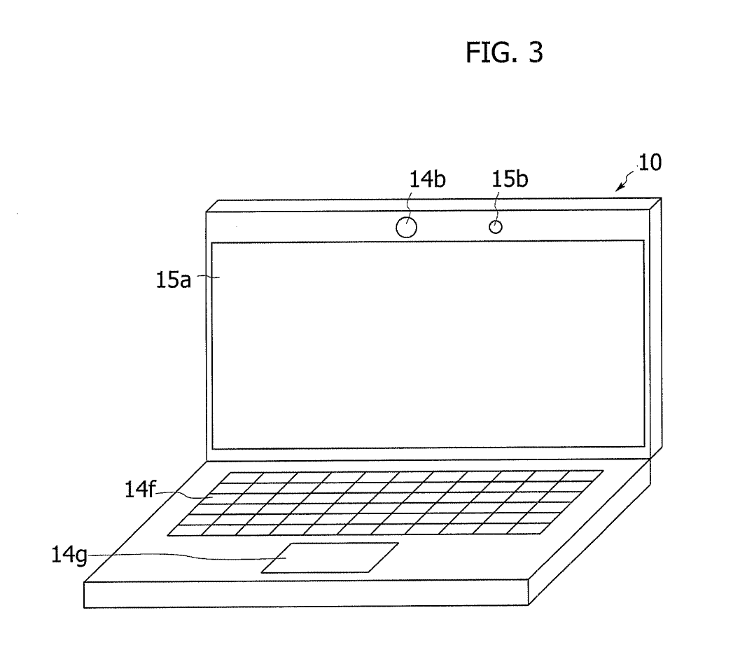

The apertures of the iris capture camera 14b and the illumination unit 15b are formed in the external wall surface provided with the display screen of the LCD 15a and other equivalent displays also in the mode of the tablet PC. FIG. 3 illustrates one example of the notebook PC by way of still another mode of the iris authentication apparatus 10. The iris authentication apparatus 10 includes the iris capture camera 14b and the illumination unit 15b also in the mode of the notebook PC similarly to FIG. 1. As depicted in FIG. 3, the iris authentication apparatus 10 based on the notebook PC includes a keyboard 14f, a touch pad 14g and the display device instanced by the LCD 15a. Also in the iris authentication apparatus 10 based on the notebook PC, the iris capture camera 14b and the illumination unit 15b are provided on the external wall surface provided with the display screen of the LCD 15a.

Incidentally, in the case of widening the angle of view of the camera in order to capture the image of the iris pattern for the authentication, this leads to an expansion of the image capture range, resulting in facilitation of unintentionally capturing images of other persons exclusive of the user defined as the iris authentication target person. The iris authentication target person will hereinafter be simply called an authenticatee. The iris authentication apparatus 10 including the wide-angle camera captures video/still images containing other persons positioned behind the user who adjusts the line of sight to the surface of the display device, i.e., the LCD 15a, for example, when implementing the authentication. In such a case that the video/still images happen to contain the unintentionally captured images of a plurality of persons when implementing the iris authentication, it follows that the plurality of persons, whose images are unintentionally captured, individually undergoes processing for the iris authentication as authentication candidates. Note that the plurality of authentication candidates will hereinafter be also simply referred to as the candidates in the following discussion.

### Examination of Process in Comparative Example

Exemplified herein as a comparative example is a process in which the iris authentication apparatus simply implements the iris authentication simply by using the wide-angle camera. The iris authentication apparatus according to the comparative example performs processing for the plurality of persons, whose images are unintentionally captured in the video/still images, individually as the iris authentication target persons. The iris authentication apparatus according to the comparative example consequently has an increased image processing throughput and an increased processing load as well. The increased processing load results in augmenting power consumption of the iris authentication apparatus. The increased image processing throughput causes elongation of processing time expended for the authentication, thereby resulting in an increase of the processing time till obtaining a result of the authentication.

The iris authentication further involves expending the time for the authentication process due to wearing eyeglasses, a color contact lenses and other equivalent eyewear as the case may be. In the iris authentication apparatus according to the comparative example, when the user as the authenticatee undergoes the iris authentication in a state of wearing the eyeglasses and other equivalent eyewear, it is assumed that a third person, whose image is captured mechanically but intentionally, will have been registered and authenticated in advance of the user. Given that the iris pattern of the malicious third person is registered as iris authentication information, the iris authentication apparatus according to the comparative example is to authenticate the iris pattern of the malicious third person and is to cancel the security. The iris authentication apparatus with its security canceled in the comparative example results in having occurrence of a leakage of the information through the malicious third person.

### Examination of Process in Embodiment

The iris authentication apparatus 10 according to the embodiment 1 identifies a relative front-and-rear positional relation between the images of the plurality of candidates contained in the video/still images based on pieces of luminance information of the video/still images when the video/still images captured by the iris capture camera 14b encompasses existences of the images of the plurality of candidates becoming iris authentication processing target persons. The iris authentication apparatus 10 specifies area ranges in which to capture the images of the candidates becoming the iris authentication processing target persons, based on the above-identified relative front-and-rear positional relation. Note that “the images of the candidates” within the video/still images will be also simply referred to as “the images”.

The iris authentication apparatus 10 according to the embodiment 1 executes the iris authentication process, based on the specified area ranges becoming iris authentication processing target ranges. The iris authentication apparatus 10 according to the embodiment 1 separates, from the specified area ranges, an image area as a background area other than these specified area ranges within the video/still images, but does not execute the iris authentication process.

The iris authentication process involves detecting the eyes containing the iris patterns of the iris authentication processing target persons based on, e.g., the specified area ranges. The iris authentication apparatus 10 extracts the iris patterns from the detected eyes. The iris authentication apparatus 10 implements the identity authentication by checking the extracted iris patterns against authentication information (reference iris images) registered in the DB. In the iris authentication process, the iris authentication apparatus 10 registers the extracted iris patterns as the authentication information (the reference iris images) in the DB.

As a result, the iris authentication apparatus 10 according to the embodiment 1 can reduce the image processing throughput in the iris authentication process. The iris authentication apparatus 10 according to the embodiment 1 can reduce the image processing throughput in the iris authentication process, and is thereby enabled to shorten the processing time expended for the authentication and to relieve the processing load on the CPU and other equivalent processors. The iris authentication apparatus 10 can relieve the processing load related to the iris authentication process and is thereby enabled to restrain the power consumption. The iris authentication apparatus 10 according to the embodiment 1 can implement the iris authentication in the natural operating posture while restraining the increase in image processing throughput.

[Configuration of Apparatus]

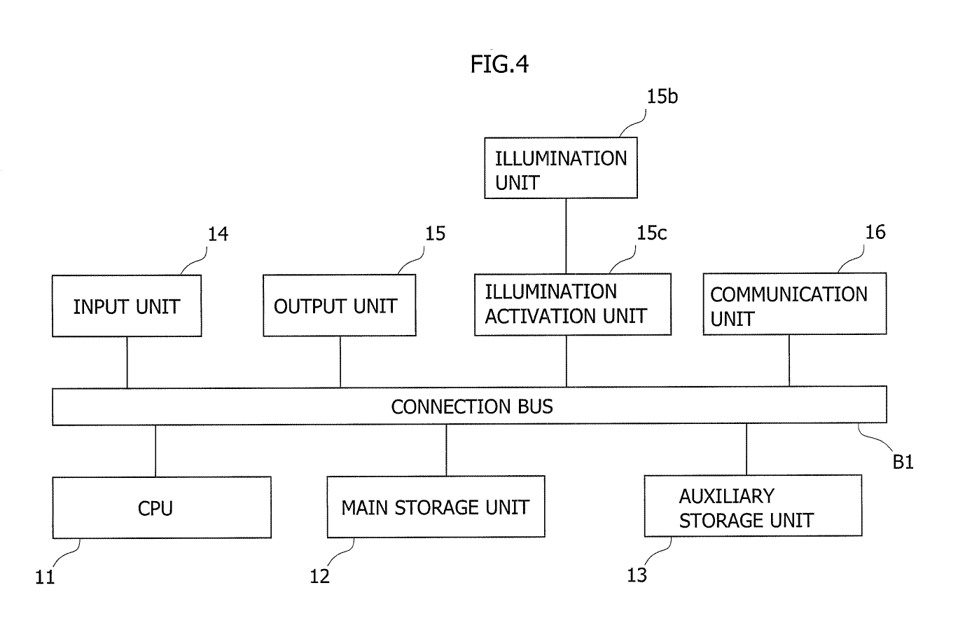

FIG. 4 illustrates one example of a hardware configuration of the iris authentication apparatus 10 according to the embodiment 1. The iris authentication apparatus 10 depicted in FIG. 4 includes a CPU 11, a main storage unit 12, an auxiliary storage unit 13, an input unit 14, an output unit 15, an illumination unit 15b, an illumination activation unit 15c and a communication unit 16, which are interconnected via a connection bus B1. The main storage unit 12 and the auxiliary storage unit 13 are non-transitory recording mediums readable by the iris authentication apparatus 10.

In the iris authentication apparatus 10, the CPU 11 deploys programs stored on the auxiliary storage unit 13 in an executable manner on a work area of the main storage unit 12 and runs the programs, thereby controlling peripheral devices. The iris authentication apparatus 10 is thereby enabled to execute processes matching with predetermined purposes.

The CPU 11 is a central processing unit that controls the whole of the iris authentication apparatus 10. The CPU 11 executes the processes in accordance with the programs stored on the auxiliary storage unit 13. The main storage unit 12 is a non-transitory storage medium used for the CPU 11 caches the programs and the data, and deploys the work area. The main storage unit 12 includes, e.g., a flash memory, a Random Access Memory (RAM) and a Read Only Memory (ROM). Note that the CPU 11 may also be a microcomputer, a chipset and other equivalent electronic components.

The auxiliary storage unit 13 stores various categories of programs and various items of data in a readable/writable manner on the recording medium. The auxiliary storage unit 13 is also called an external storage device. The auxiliary storage unit 13 stores, e.g., an Operating System (OS), the various categories of programs, various types of tables and other equivalent software components. The OS includes a communication interface program for transferring and receiving the data to and from external apparatuses connected via, e.g., the communication unit 16. The external apparatuses include, e.g., an information processing apparatus instanced by the PC and the server on a wired network and a wireless network, a portable electronic equipment instanced by a mobile phone, a smartphone, a tablet PC and a PDA, and external storage devices.

The auxiliary storage unit 13 is, e.g., an Erasable Programmable ROM (EEPROM), a solid-state drive, a hard disk drive (HDD) and other equivalent storages. For example, a CD drive, a DVD drive and a BD drive can be given as the auxiliary storage unit 13. The recording medium is exemplified by a silicon disk including a nonvolatile semiconductor memory (flash memory), a hard disk, a CD, a DVD, a BD, a Universal Serial Bus (USB) memory, and a Secure Digital (SD) memory card.

The input unit 14 accepts an operation instruction and other equivalent indications from an operator and other equivalent persons. The input unit 14 is instanced by an input button like the power button 14c and the operation button 14d, the touch sensor 14a, the touch pad 14g, the iris capture camera 14b, and an input device like a pointing device and a microphone. The input unit 14 may also be configured to include the input devices instanced by the keyboard 14f and a wireless remote controller. The pointing device includes, e.g., a touch panel configured by combining the touch sensor 14a with the display device like the LCD 15a of the output unit 15, a mouse, a track ball and a joystick. The input unit 14 includes the speech receiver 14e configured by combining the input device like the microphone with the output device like the loudspeaker, and a posture detection sensor 14h instanced by an acceleration sensor and a gyro sensor for detecting a posture of the iris authentication apparatus 10.

The output unit 15 outputs data and information that are processed by the CPU 11, and data and information that are stored on the main storage unit 12 and the auxiliary storage unit 13. The output unit 15 is, e.g., the LCD 15a (see FIGS. 1, 2 and 3). The output unit 15 may also, however, be the display device instanced by a Plasma Display Panel (PDP), an Electroluminescence (EL) panel and an organic EL panel. The output unit 15 may further be the output device instanced by a printer and the loudspeaker.

The illumination unit 15b is exemplified by a Light Emitting Diode (LED) capable of the illumination of the visible light, and an infrared LED capable of the illumination of the infrared light. The illumination activation unit 15c is a control device including a current circuit and other equivalent circuits for activating the LED of the illumination unit 15b.

The communication unit 16 is an interface with the wired network, the wireless network and other equivalent networks for establishing the connection to the iris authentication apparatus 10. The wired network includes, e.g., a public network instanced by the Internet, a Local Area Network (LAN), and other equivalent networks. The wireless networks include a mobile phone network, a wireless LAN, and Bluetooth (registered trademark). Note that the communication unit 16 may be provided in the form of a communication adapter like a wireless LAN adapter fitted to a USB port and other equivalent ports possessed by the iris authentication apparatus 10.

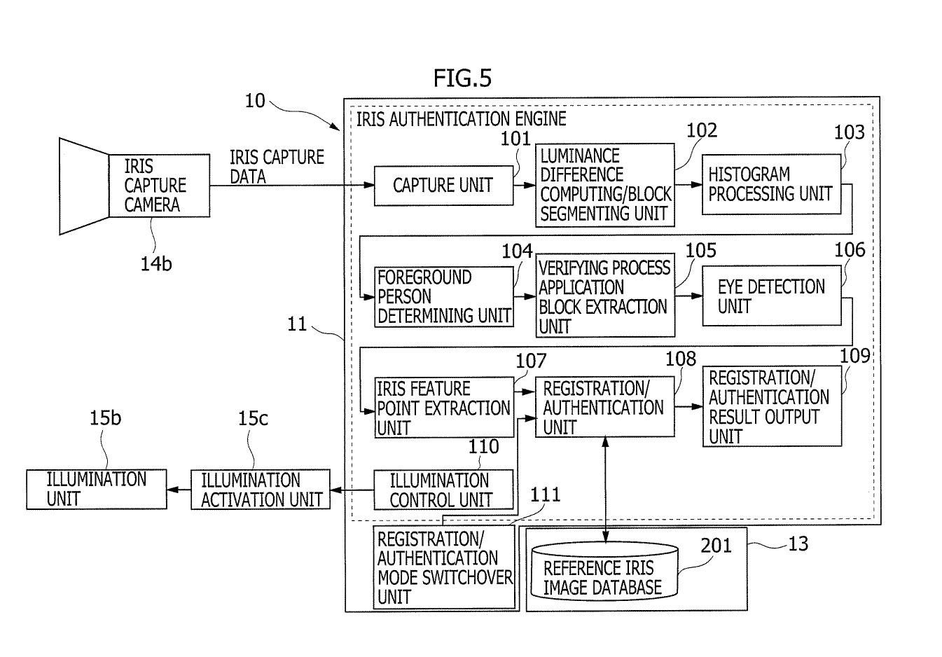

In the iris authentication apparatus 10, the CPU 11 reads the OS, the various categories of programs and the various items of data that are stored on the auxiliary storage unit 13 onto the main storage unit 12, and runs target programs as well as implementing these software components, thereby providing the respective processing units illustrated in FIG. 5.

As depicted in FIG. 5, the iris authentication apparatus 10 provides, by way of the processing units attained by running the target programs, a capture unit 101, a luminance difference computing/block segmenting unit 102, a histogram processing unit 103, a foreground person determining unit 104, and a verifying process application block extraction unit 105. Likewise, the iris authentication apparatus 10 provides an eye detection unit 106, an iris feature point extraction unit 107, a registration/authentication unit 108, a registration/authentication result output unit 109, an illumination control unit 110, and a registration/authentication mode switchover unit 111.

However, any one or part of these processing units illustrated in FIG. 5 may be processed by a hardware circuit. The iris authentication apparatus 10 includes, e.g., a reference iris image DB201, provided in the auxiliary storage unit 13, to which the respective processing units described above refer, or alternatively as a storage location of the data to be managed by these processing units.

[Configurations of Processing Units]

FIG. 5 illustrates an explanatory diagram of the processing units of the iris authentication apparatus 10 according to the embodiment 1. Note that the iris capture camera 14b, the illumination unit 15b and the illumination activation unit 15c have already been described in FIGS. 1 and 4.

In the explanatory diagram depicted in FIG. 5, the registration/authentication mode switchover unit 111 accepts, e.g., an operation input instruction for authenticating the iris of the user and other equivalent persons via the input unit 14. The registration/authentication mode switchover unit 111 similarly accepts another operation input instruction for registering the iris pattern of the user and other equivalent persons as the authentication information. The registration/authentication mode switchover unit 111 temporarily stores the accepted operation input instructions in a predetermined area of the main storage unit 12 via the input unit 14. The registration/authentication mode switchover unit 111 hands over, e.g., the accepted operation input instructions to the registration/authentication unit 108.

The iris authentication apparatus 10 accepts, e.g., a pressing operation on the power button 14c, the pressing operation on the power button 14c being accepted as the operation input instruction for implementing the iris authentication by the iris authentication apparatus 10. The iris authentication apparatus 10 reaching a halt state because of no occurrence of the operation inputs over a fixed period of time, accepts the pressing operation such as a long press of, e.g., the operation button 14d as the operation input instruction for the iris authentication when returning to an operation state. The registration/authentication mode switchover unit 111 accepts the operation input instructions described above.

The iris authentication apparatus 10 accepts the operation input with respect to, e.g., an operation component for registering the iris pattern in the operation state. The iris authentication apparatus 10 displays, e.g., selection items of the operation input with respect to the operation components for registering the iris pattern, and may simply accept the operation from the user.

In the case of including the touch panel, the iris authentication apparatus 10 accepts, as the operation input instruction, a touch operation of the user who touches the operation component by superposing a finger or a touch tool on a display position thereof. The iris authentication apparatus 10 may also accept the operation from the user via the mouse, the touch pad 14g or the keyboard 14f. It may be sufficient that the iris authentication apparatus 10 accepts, e.g., a determination input as in the operation input instruction to a cursor superposed on the display position of the operation component by use of the mouse and other equivalent devices. The registration/authentication mode switchover unit 111 accepts the foregoing operation input instructions for registering the iris pattern.

The iris authentication apparatus 10 executes a process of registering the iris pattern as the authentication information or the iris authentication when the iris authentication apparatus 10 accepts the operation input instruction for implementing the iris authentication or the operation input instruction for registering the iris pattern.

As described by using FIG. 1 and other drawings, in the iris authentication or in the process of registering the iris pattern, the iris authentication apparatus 10 captures the image of the iris of the target person illuminated with the illumination light emitted by the illumination unit 15b by using the iris capture camera 14b. The iris authentication apparatus 10 identifies the relative front-and-rear positional relation between the images, contained in the video/still images, of the plurality of candidates based on the pieces of luminance information of the video/still images captured by the iris capture camera 14b.

A relationship to be explained next is established between the luminance information of the video/still images captured by the iris capture camera 14b and the relative front-and-rear positional relation between (the images of) the plurality of candidates contained in the video/still images.

Let “Ie(W/sr(steradian))” be a radiant intensity as an intensity of the illumination light of the illumination unit 15b and “dP(W)” be a radiant energy (radiant flux) passing through “dω(sr)” defined as a minute solid-angle in a direction of an optical axis of the illumination unit 15b, and this radiant energy dP(W) can be expressed by the following formula (1).

dP=(Ie)×(dω) Formula (1)

When a minute planar dimension “ds(m2)” of a portion spaced at a distance “r(m)” in the optical-axis direction from the illumination unit 15b is viewed from this illumination unit 15b, a minute solid-angle “dω(sr)” can be expressed by the following formula (2).

dω=(dS)/(r²) Formula (2)

Irradiance defined as the radiant energy, which is incident on the unit planar dimension of the portion spaced at the distance “r(m)” in the optical-axis direction from the illumination unit 15b, can be expressed by the following formula (3).

dP/dS=(Ie)/(r²) Formula (3)

It is comprehended from the formula (3) that the irradiance “dP/dS” is inversely proportional to a square of the distance. In other words, it follows that the irradiance decreases to a greater degree in inverse proportion to the square of the distance as the image capture target is distanced farther from the illumination unit 15b.

A precondition is herein assumed such that the image capture target illuminated by the illumination unit 15b is plain with neither colors nor patterns, and the illumination unit 15b is a point light source. A relationship expressed by the following formula (4) is established between illuminance of the image capture target illuminated by the illumination unit 15b and the luminance of the video/still images obtained by capturing the image of the image capture target.

Luminance [symbol] Illuminance [symbol] 1/r²) Formula (4)

It is understood from the formula (4) that the luminance of each set of pixel points of the video/still images of the image capture target captured by the iris capture camera 14b is inversely proportional to the square of the distance to the image capture target under the aforementioned precondition. For example, the distance to the image capture target can be estimated based on the relationship given in the formula (4) from the luminance of the sets of pixel points in the video/still images.

Note that the irradiance, as given in the formula (3), decreases in inverse proportion to the square of the distance to the image capture target from the illumination unit 15b, and has the relationship of being proportional to the radiant intensity (le) of the illumination unit 15b. Hence, when illuminating the image capture target with the illumination light of the illumination unit 15b in a way that varies the radiant intensity of the illumination light, it follows that the following relationship is established with respect to a luminance difference between the sets of pixel points within the captured video/still images.

To be specific, such a relationship is established that the luminance difference at pixel points between the video/still images captured while varying the radiant intensity becomes larger as having a closer distance between the image capture target and the illumination unit 15b. While on the other hand, such a relationship is established that the luminance difference at the pixel points between the video/still images captured while varying the radiant intensity becomes smaller as having a farther distance between the image capture target and the illumination unit 15b.

The iris authentication apparatus 10 identifies the relative front-and-rear positional relation between the images of the plurality of candidates contained in the video/still images based on the luminance between the sets of pixel points within the video/still images captured by the illumination light having the different radiant intensities. The iris authentication apparatus 10 thus identifies the image of the candidate positioned at the foreground with the closest distance from the illumination unit 15b. The iris authentication apparatus 10 specifies an image capture area of the image of the identified candidate as an area range becoming the iris authentication processing target. The iris authentication apparatus 10 detects the eye based on the specified area range, and implements the iris authentication based on the iris pattern contained in the detected eye.

In the explanatory diagram illustrated in FIG. 5, the illumination control unit 110 controls the illumination activation unit 15c to emit the illumination light having the different radiant intensities from the illumination unit 15b. The illumination activation unit 15c activates the illumination unit 15b to differentiate the radiant intensities of the illumination light emitted from the illumination unit 15b, based on control information outputted from the illumination control unit 110.

The different radiant intensities are set as a radiant intensity A and a radiant intensity B, respectively. A relation between these radiant intensities is given such as radiant intensity A>>radiant intensity B. The relation given by “radiant intensity A>>radiant intensity B” has such a connotation that this radiant intensity relation is sufficient for determining a relation in which the luminance difference at the pixel points between the video/still images captured in the way of varying the radiant intensity becomes larger as having the closer distance between the image capture target and the illumination unit 15b. The image capture target is illuminated with the illumination light having the relation given by “radiant intensity A>>radiant intensity B”, whereby the image having the luminance difference enabling the above relation to be determined can be acquired. As will be described in FIG. 8, the relative front-and-rear positional relation with respect to the images of the plurality of candidates is identified based on a threshold value from the luminance difference images, and the image capture area of the image of the candidate positioned at the foreground can be thereby specified. The relation between the different radiant intensities may be satisfactory on the condition that values of the substantially distinguishable luminance differences are sufficiently spaced from each other based on the threshold value.

The illumination activation unit 15c varies, e.g., an electric current, a voltage and electric power that are applied to the illumination unit 15b so as to emit the illumination light having the radiant intensities A, B based on the control information outputted from the illumination control unit 110. Alternatively, when the illumination unit 15b has two types of light sources of the radiant intensities A, B, the illumination activation unit 15c switches over the light sources having the different radiant intensities, based on the control information outputted from the illumination control unit 110.

The illumination unit 15b illuminates the image capture target person having the iris pattern with the illumination light of the radiant intensities A, B based on the control information of the illumination control unit 110. An image of the image capture target person illuminated with the illumination light of the radiant intensities A, B is captured by the iris capture camera 14b.

As explained in FIG. 1 and other drawings, the iris capture camera 14b captures the video/still images at a frame rate instanced by 30 Frames Per Second (FPS). The image of the image capture target person illuminated with the illumination light of the radiant intensities A, B is captured at the 30 FPS.

The relative front-and-rear positional relation between the images of the plurality of candidates contained in the video/still images can be, however, identified based on the luminance difference at the pixel points between the video/still images captured by being illuminated with the illumination light of the different radiant intensities. It may be therefore sufficient to have at least one-frame of the video/still images captured by being illuminated with the radiant intensity A and one-frame of the video/still images captured by being illuminated with the radiant intensity B. For example, a shooting period of one frame is 33 ms at the frame rate of 30 FPS.

For example, the illumination control unit 110 may control the illumination light illuminated from the illumination unit 15b so that an illumination period of each of the radiant intensities A, B becomes 33 ms, i.e., one-frame period. It can be expected to restrain the power consumption of the iris authentication apparatus 10 by restricting the illumination period of the illumination light. In the case of restricting the illumination period of the illumination light to one-frame period, it is feasible to set, e.g., the illumination period of the radiant intensity B in continuation immediately after the illumination period of the radiant intensity A.

Note that when using the visible light as the illumination light, for example, the relative front-and-rear positional relation between the images of the candidates can be identified based on the luminance difference at the pixel points between the video/still images captured in an illuminated state of illuminating the visible light, and based on the luminance difference at the pixel points between the video/still images captured in a state under such an ambient light as not to illuminate the visible light. In this case, the illumination control unit 110 may control the illumination light so that the illumination period of the visible light becomes 33 ms as one-frame period. The restraint of the power consumption of the iris authentication apparatus 10 can be expected even when using the visible light as the illumination light. The following discussion will describe that the illumination unit 15b illuminates the illumination light having the different radiant intensities A, B.

In the explanatory diagram illustrated in FIG. 5, the capture unit 101 accepts the video/still images (containing the iris capture data) captured by the iris capture camera 14b. The capture unit 101 extracts, from the accepted video/still images, the still images captured by being illuminated with the illumination light of the radiant intensity A and the still images captured by being illuminated with the illumination light of the radiant intensity B. The capture unit 101 temporarily stores the extracted still images captured by being illuminated with the illumination light of the radiant intensities A, B in, e.g., a predetermined area of the main storage unit 12. The capture unit 101 hands over the extracted still images to the luminance difference computing/block segmenting unit 102.

The still images captured by being illuminated with the illumination light of the radiant intensities A, B may also be extracted based on the control information of the illumination control unit 110. A phrase “being extracted based on the control information of the illumination control unit 110” implies that the illumination control unit 110 acquires, e.g., illumination timings of the illumination light of the radiant intensities A, B as the control information, and extracts the still images corresponding to the illumination timings of the illumination light of the radiant intensities A, B. The extraction based on the control information of the illumination control unit 110 enables the still images captured by being illuminated with the illumination light of the radiant intensities A, B to be extracted from within the video/still images captured at the predetermined frame rate.

In the iris authentication apparatus 10, e.g., the timings of illuminating the illumination light are preset, and the capture unit 101 may extract the still images captured by being illuminated with the illumination light of the radiant intensities A, B based on the preset timings. For example, the preset timings can be exemplified such as illuminating the illumination light of the radiant intensity A for the shooting period of first frame upon a start of shooting, and illuminating the illumination light of the radiant intensity B for the shooting period of second frame immediately subsequent to the first frame.

The luminance difference computing/block segmenting unit 102 generates the luminance difference images by calculating the luminance difference at the pixel points between the video/still images captured by being illuminated with the illumination light of the radiant intensities A, B. The luminance difference computing/block segmenting unit 102 segments the generated luminance difference images into a predetermined number of block areas. The predetermined number of block areas obtained by the segmentation are handed over to the histogram processing unit 103.

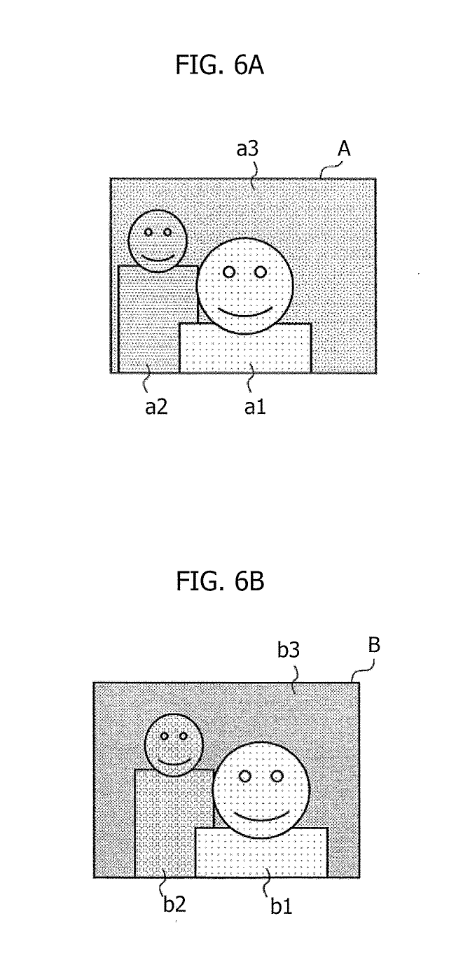

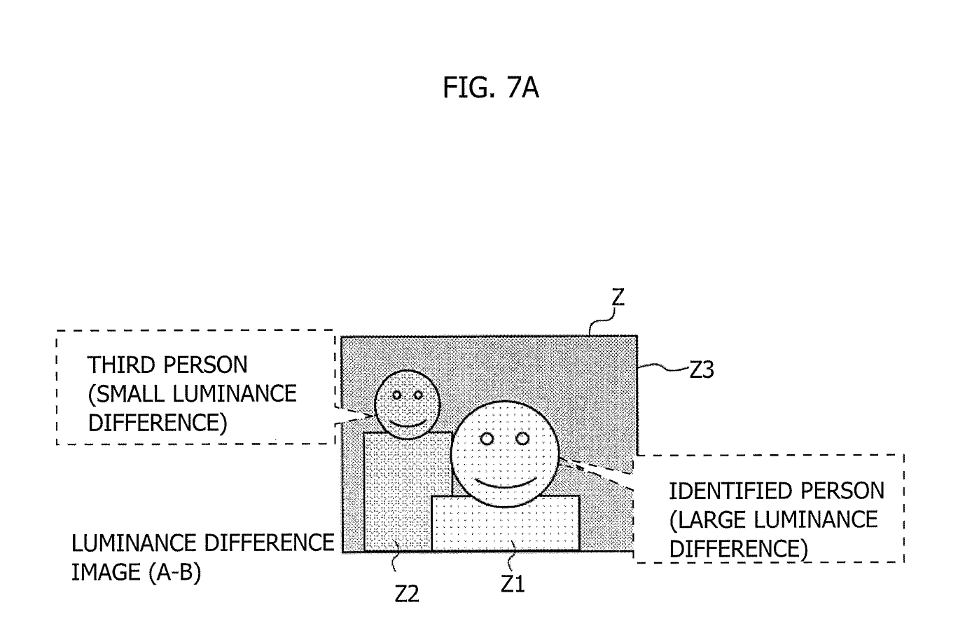

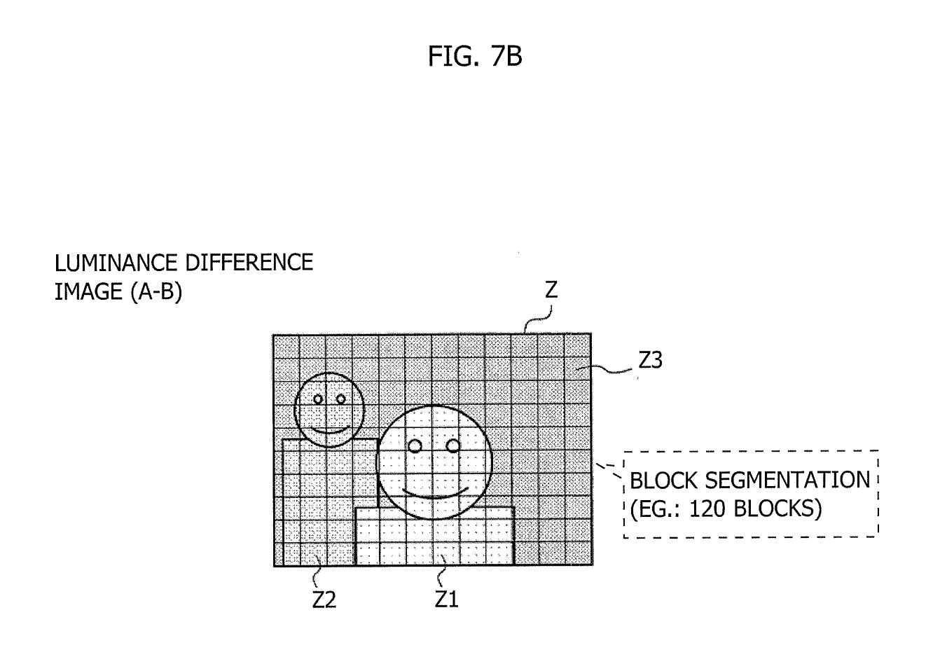

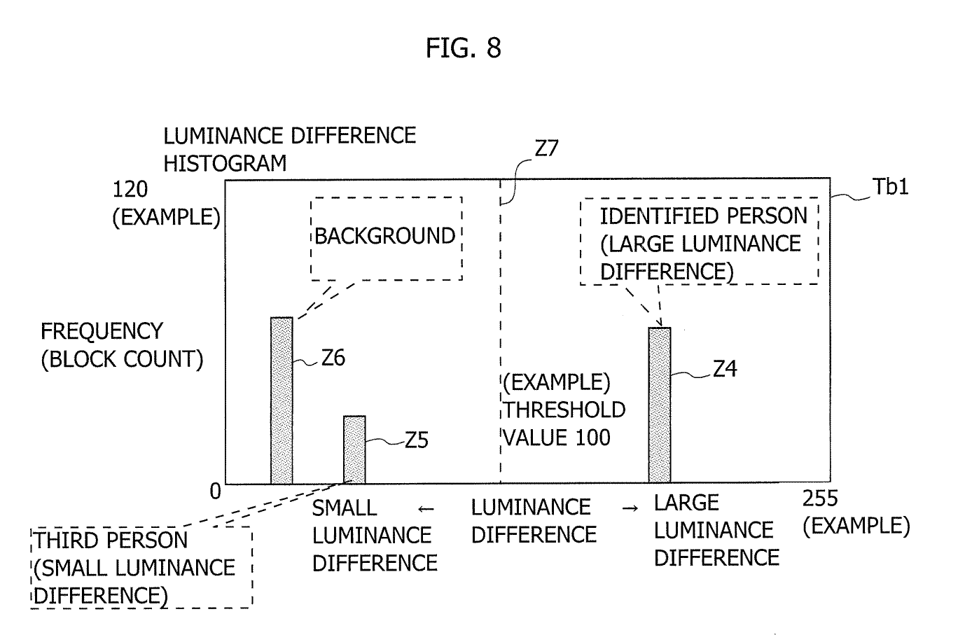

A process of luminance difference computing/block segmenting unit 102 will be described with reference to explanatory diagrams in FIGS. 6A, 6B, 7A and 7B. FIGS. 6A-6B are the explanatory diagrams of the video/still images captured by being illuminated with the illumination light of the different radiant intensities. FIGS. 7A-7B are the explanatory diagrams of segmentation into the block areas based on luminance difference images.

In FIG. 6A, the video/still images A are an example of the video/still images captured by being illuminated with the illumination light of the radiant intensity A. The video/still images A contain an area range a1 defined as the captured image of the identified authenticatee, and an area range a2 defined as a captured image of the third person unintentionally captured when shooting. Note that a background area (area range a3) captured as a background is an area exclusive of the area ranges a1, a2 in the video/still images A.

In FIG. 6B, the video/still images B are an example of the video/still images captured by being illuminated with the illumination light of the radiant intensity B. The video/still images B contain an area range b1 defined as the captured image of the identified authenticatee, and an area range b2 defined as a captured image of the third person unintentionally captured when shooting. Similarly to the video/still images A, a background area (area range b3) captured as the background is an area exclusive of the area ranges b1, b2 in the video/still images B.

It is assumed in the video/still images A, B that the identified authenticatee and the third person unintentionally captured when shooting are in the front-and-rear positional relation. A luminance relation at the pixel points between the area ranges a1-a3 within the video/still images A is given such as Area Range a1>Area Range a2>Area Range a3. A luminance relation at the pixel points between the area ranges b1-b3 within the video/still images B is given such as Area Range b1>Area Range b2>Area Range b3. This is because the luminance at each pixel point is, as described in the formula (4), inversely proportional to the square of the distance to the image capture target.

However, the video/still images A, B respectively contain an ambient illumination component when shooting and color components and other equivalent components of the image capture target persons. Therefore, e.g., in the case of estimating the positional relation between the identified authenticatee and the third person unintentionally captured when shooting by use of the luminance information of the pixel points contained in the area ranges a1-a3 within the video/still images A, it follows that uncertainty arises in the estimated positional relation. The same as the uncertainty arising therein is applied also to the case of the video/still images B.

The luminance difference computing/block segmenting unit 102 generates the luminance difference image by calculating the luminance difference at the pixel points between the video/still images A and the video/still images B in order to remove the ambient light component when shooting and the color component and other equivalent components of the image capture target person.

Herein, as described about the capture unit 101, the video/still images A, B are the extracted frames of images captured for one shooting period and another subsequent shooting period. A positional deviation of the image capture areas between the video/still images A and B can be therefore deemed minute. However, when the positional deviation occurs in the image capture areas between the video/still images A and B, for example, the luminance difference computing/block segmenting unit 102 may also perform positioning correction so that the area range a1 of the video/still images A and the area range b1 of the video/still images B are coincident within a predetermined fixed range. The luminance difference computing/block segmenting unit 102 temporarily stores the generated luminance difference image in the predetermined area of the main storage unit 12.

FIG. 7A illustrates a luminance difference image Z calculated from the video/still images A and B. The luminance difference image Z is equivalent to luminance difference image (A-B) based on the difference between the luminance at the pixel points contained in the video/still images A and the luminance at the pixel points contained in the video/still images B.

In the luminance difference image Z, an area range z1 is a luminance difference area corresponding to the luminance difference between the area range a1 of the video/still images A and the area range b1 of the video/still images B. Likewise, an area range z2 is a luminance difference area corresponding to the luminance difference between the area range a2 of the video/still images A and the area range b2 of the video/still images B. An area range z3 is a luminance difference area corresponding to the luminance difference between the area range a3 of the video/still images A and the area range b3 of the video/still images B.

As described in the formulae (3) and (4), such a relation exists that the luminance difference at the pixel points between one set of video/still images and another set of video/still images, which are captured in the way of varying the radiant intensity, becomes larger as the image capture target and the illumination unit 15b get closer in distance. Such a relation also exists that the luminance difference at the pixel points between one set of video/still images and another set of video/still images, which are captured in the way of varying the radiant intensity, becomes smaller as the image capture target and the illumination unit 15b get remoter in distance.

Accordingly, in FIG. 7A, the relative front-and-rear positional relation within the video/still images can be estimated by mutually comparing the luminance differences between the area range z1, the area range z2 and the area range z3.

For example, when the identified authenticatee and the third person whose image is unintentionally captured when shooting are in the front-and-rear positional relation, the area range exhibiting the largest luminance is the area positioned at the foreground when being shot for the authentication, i.e., can be estimated as the image capture area of the identified authenticatee. For instance, in the luminance difference image Z of FIG. 7A, a magnitude relation of the luminance difference between the respective area ranges is given such as Area Range z1>Area Range z2>Area Range z3.

The luminance difference computing/block segmenting unit 102 segments the generated luminance difference image Z into the plurality of block areas in order to compare the magnitude relation of the luminance difference. A segmentation count of the block areas can be arbitrarily set corresponding to, e.g., a pixel count of the video/still images, the radiant intensity of the illumination light, a processing performance of the iris authentication apparatus 10, and other equivalent elements.

FIG. 7B illustrates a segmentation example of how the luminance difference image Z is segmented into the block areas. FIG. 7B illustrates the example of segmenting the luminance difference image Z into 120 pieces of rectangular block areas. The luminance difference computing/block segmenting unit 102 segments the luminance difference image Z by 10 rows arranged in a vertical direction and by 12 columns arranged in a horizontal direction into 120 rectangular block areas. The segmented block areas are allocated with identifying information per block area. The luminance difference computing/block segmenting unit 102 allocates, e.g., an address (1, 1) as the identifying information to the block area covering a left upper angled portion of the luminance difference image Z, and an address (12, 10) as the identifying information to the block area covering a right lower angled portion. In the case of designating the address by “Y” in the vertical direction and the address by “X” in the horizontal direction, the segmented block areas are identified as 2-dimensional information such as (X, Y) [X=1 . . . 12, Y=1 . . . 10].

The luminance difference computing/block segmenting unit 102 temporarily stores the segmented block areas and the pieces of identifying information for identifying the block areas by being associated with each other in a predetermined area of the main storage unit 12. The luminance difference computing/block segmenting unit 102 hands over the segmented block areas together with the identifying information to the histogram processing unit 103.

The histogram processing unit 103 totalizes the luminance differences of the pixels per segmented block area, and calculates an average value of the luminance differences. The histogram processing unit 103 generates a histogram of the luminance differences based on the average value of the luminance differences, which is calculated per block area.

For example, the histogram processing unit 103 temporarily stores the luminance difference average value calculated per block area by being associated with the address of the block area in a predetermined area of the main storage unit 12. The histogram processing unit 103 further totalizes numerical quantities of the block areas in which the calculated average value of the luminance differences falls within the predetermined range.

The predetermined range herein connotes a residual error with a dispersion of the average value of the luminance differences, and can be preset based on the data and other equivalent information acquired from experiments. Note that the luminance at the pixel point is, described in the formula (4), inversely proportional to the square of the distance to the image capture target, and hence the predetermined range may also be set based on a variation of the luminance at a fixed unit distance, e.g., 5 cm.

The histogram processing unit 103 delimits the calculated average value of the luminance difference by a predetermined range, and generates a luminance difference histogram by associating a range of the delimited average value with the totalized numerical quantity of the block areas. The histogram processing unit 103 hands over the generated luminance difference histogram to the foreground person determining unit 104.

FIG. 8 illustrates an explanatory diagram of the luminance difference histogram. A luminance difference histogram Tb1 depicted in FIG. 8 is one example of the luminance difference histogram of the luminance difference image Z segmented into the 120 rectangular block areas. The axis of ordinate of the luminance difference histogram Tb1 indicates a frequency (occurrence frequency) of the average value of the luminance differences, which is calculated per block area. The frequency of the average value of the luminance differences can be expressed as, e.g., the numerical quantity (a number of blocks) of the block areas in which the calculated average value of the luminance differences falls within the predetermined range. The axis of abscissa of the luminance difference histogram Tb1 indicates the average value of the luminance differences per block area, which is calculated by the histogram processing unit 103.

It is understood from the luminance difference histogram Tb1 generated from the luminance difference image Z that the frequency of the average value of the luminance differences distributes at three points as indicated by frequency areas z4-z6 in FIG. 8. The frequency area z4 in FIG. 8 corresponds to a block area group within the area range z1 in FIG. 7B, and the frequency area z5 in FIG. 8 corresponds to a block area group within the area range z2 in FIG. 7B. The frequency area z6 in FIG. 8 corresponds to a block area group within the area range z3 in FIG. 7B.

It is comprehended from the luminance difference histogram Tb1 illustrated in FIG. 8 and generated from the luminance difference image Z that a magnitude relation between the average values of the luminance differences is given such as Frequency Area z4>>Frequency Area z5>Frequency Area z6. Namely, the luminance difference of the frequency area z4 is larger than the luminance difference of the frequency area z5, and the luminance difference of the frequency area z5 is larger than the luminance difference of the frequency area z6. A difference between the luminance difference of the frequency area z4 and the luminance difference of the frequency area z5, is larger than a difference between the luminance difference of the frequency area z5 and the luminance difference of the frequency area z6.

The foreground person determining unit 104 specifies the frequency area having the largest luminance difference from within the luminance difference histogram Tb1 generated from the luminance difference image Z. The luminance at the pixel points of the video/still images captured by the iris capture camera 14b can be expressed as, e.g., 0-255 valued image data of 8-bit gradations. The foreground person determining unit 104 specifies the frequency area having the largest luminance difference on the condition that the luminance difference value exceeds, e.g., a predetermined threshold value.

Note that data of the luminance difference histogram are empirically acquired, and the threshold value (luminance difference threshold value) for specifying the frequency area can be set based on the acquired data. For example, when the luminance at the pixel points of the video/still images are expressed by the 8-bit gradations, the luminance difference threshold value can be exemplified by a luminance value that is equal to or larger than “100”. The threshold value (100) is, however, an exemplification, and other luminance difference values may also be each set as the threshold value.

In the luminance difference histogram Tb1 depicted in FIG. 8, a broken line z7 represents the luminance difference threshold value that is the luminance difference value “100”. As illustrated in FIG. 8, when the luminance difference threshold value is set to the luminance difference value “100”, it follows that the frequency area z4 exceeds the luminance difference threshold value, while the frequency areas z5, z6 are under the luminance difference threshold value.

The foreground person determining unit 104 specifies the frequency area z4 exceeding the luminance difference threshold value as the frequency area having the large luminance difference. The frequency area z4 specified by the foreground person determining unit 104 corresponds to the image capture area of the person whose image is captured in the foreground position when capturing the image of the iris pattern. The foreground person determining unit 104 temporarily stores the frequency area z4 exceeding the luminance difference threshold value in a predetermined area of the main storage unit 12. The foreground person determining unit 104 hands over the identifying information of the block area group corresponding to the frequency area z4 exceeding the luminance difference threshold value, to the verifying process application block extraction unit 105.

The verifying process application block extraction unit 105 specifies the area range becoming the iris authentication processing target, based on the identifying information of the block area group corresponding to the frequency area z4. The verifying process application block extraction unit 105 extracts, e.g., the block area group covered by the area range z1 illustrated in FIG. 7B as the area range becoming the iris authentication processing target.

Accordingly, in the luminance difference image Z depicted in FIG. 7B, e.g., the area ranges z2, z3 excluding the area range z1 are separated from the iris authentication process target range. Consequently, the area ranges z2, z3 depicted in FIG. 7B do not undergo processing by the eye detection unit 106, the iris feature point extraction unit 107, the registration/authentication unit 108 and the registration/authentication result output unit 109.

The verifying process application block extraction unit 105 temporarily stores, e.g., the block area group corresponding to the specified area range by being associated with the identifying information thereof in a predetermined area of the main storage unit 12. The verifying process application block extraction unit 105 hands over the specified area range to the eye detection unit 106.

The eye detection unit 106 detects the eyes of the person (authentication target person) positioned at the foreground within the video/still images, based on the area range specified by the verifying process application block extraction unit 105. The eyes in the specified area range within the video/still images are detected by detecting the illumination light reflecting on the eyes in the form of optical spheres. The optical spheres reflecting on the eyes illuminated with the illumination light within the video/still images can be detected as bright points corresponding to sizes of the eyes. The eye detection unit 106 detects a pair of optical spheres, which are captured in the two eyes of the authentication target person, from within the specified area range. The optical spheres, which are captured in the two eyes of the authentication target person, can be detected as bright point areas aligned apart corresponding to a clearance of the two eyes within the video/still images.

The eye detection unit 106 may also detect a face of the authentication target person from the specified area range within the video/still images by, e.g., a face recognition technology based on face features such as the eyes, a nose, a mouth and other equivalent regions. The eye detection unit 106 can detect the eyes, based on the detected face of the authentication target person. The eye detection unit 106 hands over the areas of the detected eyes within the video/still images to the iris feature point extraction unit 107.

Incidentally, such a case is assumed that the illumination light does not have the radiant intensities sufficient for detecting the eyes in the video/still images captured for generating the luminance difference image. This is a case in which the radiant intensities A, B of the illumination light for obtaining the luminance difference image are lower than, e.g., a radiant intensity C for obtaining the video/still images sufficient for detecting the eyes.

In the case described above, the iris authentication apparatus 10 may capture the new video/still images by using the illumination light having, e.g., the radiant intensity C, and may execute the processing by the eye detection unit 106 with respect to the newly captured video/still images. The eyes are detected from the video/still images captured by using the illumination light having the radiant intensity C with respect to the area range specified based on the luminance difference image. This is because the authentication target person is within a minute quantity of movement during a period till being notified of a result of the iris authentication process.

The iris feature point extraction unit 107 extracts the iris patterns as the features of the iris patterns of the authentication target person from the eyes detected within the video/still images. The iris feature point extraction unit 107 extracts the iris patterns respectively from the right and left eyes of the authentication target person. The iris feature point extraction unit 107 hands over the extracted iris patterns to the registration/authentication unit 108.

The registration/authentication unit 108 authenticates the irises of the authentication target person based on the right-and-left eye iris patterns handed over from the iris feature point extraction unit 107, or alternatively registers the iris patterns as the authentication information in the reference iris image DB201.

On the occasion of the iris authentication, the registration/authentication unit 108 checks the right-and-left eye iris patterns handed over from the iris feature point extraction unit 107 against the iris patterns registered in the reference iris image DB201. The registration/authentication result output unit 109 is notified of a check result. The registration/authentication result output unit 109 displays the check result notified from the registration/authentication unit 108 on the display device, i.e., the LCD 15a of the iris authentication apparatus 10.

Note that when the right-and-left eye iris patterns handed over from the iris feature point extraction unit 107 are not verified with the iris patterns registered in the reference iris image DB201, the registration/authentication unit 108 iterates the iris authentication based on the new video/still images. This is because the extracted iris patterns do not have an information quantity sufficient for performing the verification as the case may be. Such a case can be exemplified that iris regions are covered with eyelashes, eyelids and other equivalent objects. Note that when not verified, an iteration count can be set corresponding to the number of pixels of the video/still images, the processing performance of the iris authentication apparatus 10, and other equivalent items. Further, when not verified, a period for iterating the verifying process may also be set corresponding to a period till outputting the check result.

When registering the iris patterns, the registration/authentication unit 108 registers the right-and-left eye iris patterns handed over from the iris feature point extraction unit 107 as the authentication information in the reference iris image DB201. As described above, however, the extracted iris patterns do not have the information quantity sufficient for performing the verification as the case may be. When the extracted iris patterns correspond to the case that the iris regions are covered with the eyelashes, eyelids and other equivalent objects, the registration/authentication unit 108 may be set to capture the new video/still images. For example, when there are extracted the iris patterns with the iris regions not being covered with the eyelashes, eyelids and other equivalent objects, the registration/authentication unit 108 may simply register the extracted iris patterns in the reference iris image DB201.

[Processing Flow]

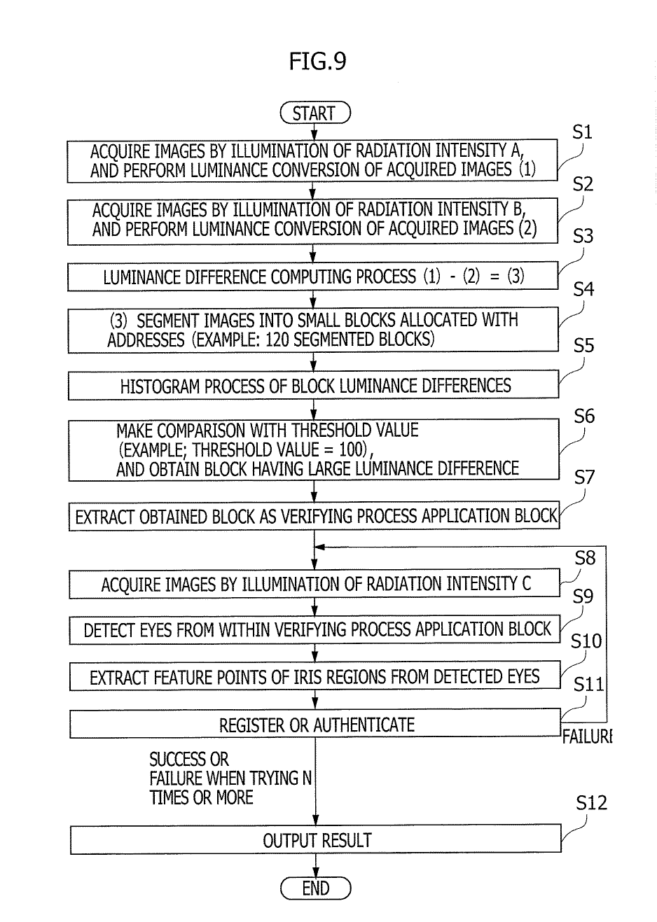

Processes of the iris authentication apparatus 10 according to the embodiment 1 will hereinafter be described with reference to a flowchart illustrated in FIG. 9. FIG. 9 illustrates the flowchart of the processes related to the iris authentication by the iris authentication apparatus 10. Note that the flowchart illustrated in FIG. 9 is, as described in FIG. 5, a processing example in the case of acquiring the video/still images by using the illumination light having the radiant intensity C for detecting the eyes.

The CPU 11 reads the OS, the various categories of programs and the various items of data that are stored in the auxiliary storage unit 13 onto the main storage unit 12 and runs these software components, whereby the iris authentication apparatus 10 executes the processes related to the iris authentication illustrated in FIG. 9. The iris authentication apparatus 10 executes the processes related to the iris authentication illustrated in FIG. 9 by referring to the reference iris image DB201 or as a storage location of the data to be managed.

In the flowchart illustrated in FIG. 9, a start of the processes related to the iris authentication by the iris authentication apparatus 10 can be exemplified such as when being triggered by accepting the operation input instruction to implement the iris authentication of the user and other equivalent persons. The operation input instruction to implement the iris authentication of the user and other equivalent persons has already been described by using FIG. 5.

The iris authentication apparatus 10, upon a trigger of the operation input instruction, illuminates the illumination light having the different radiant intensities via the illumination unit 15b. In the iris authentication apparatus 10, the iris capture camera 14b captures the video/still images of the plurality of candidates including the user as the authentication target person, who are illuminated with the illumination light having the different radiant intensities. The image capture using the illumination light having the different radiant intensities has already been explained in FIG. 5. The following description will be made on the premise that the illumination unit 15b illuminates the illumination light having the radiant intensities A, B (A>>B) as the different radiant intensities.

The iris authentication apparatus 10 acquires the video/still images captured by being illuminated with the illumination light of, e.g., the radiant intensity A. The iris authentication apparatus 10 converts the luminance of the acquired video/still images (S1). The luminance of the video/still images are converted at every pixel point.

The pixel points of the video/still images captured by the iris capture camera 14b are expressed in R, G, B with the 8-bit gradations. In this case, a luminance value (Y) at the pixel point can be expressed by (Y)=0.299×R+0.587×G+0.114×B. The iris authentication apparatus 10 converts the luminance of the video/still images based on a relational expression given above at every pixel point contained in the video/still images captured by being illuminated with the illumination light of the radiant intensity A. The iris authentication apparatus 10 hands over converted images after converting the luminance to a process in S3.

Likewise, the iris authentication apparatus 10 acquires the video/still images captured by being illuminated with the illumination light of the radiant intensity B. The iris authentication apparatus 10 converts the luminance of the video/still images acquired by the same way as the process in S1 (S2). The luminance of the video/still images are converted, e.g., at every pixel point. The iris authentication apparatus 10 hands over the converted images after converting the luminance to the process in S3.

The iris authentication apparatus 10 executes a luminance difference computing process, based on the converted images after converting the luminance, which are handed over from the processes in S1-S2 (S3). The luminance difference computing process has already been described by using FIGS. 5, 6 and 7. For example, the luminance difference image Z depicted in FIG. 7A is generated by the luminance difference computing process. The iris authentication apparatus 10 temporarily stores the generated luminance difference image Z in a predetermined area of the main storage unit 12. The iris authentication apparatus 10 hands over the luminance difference image Z generated as a result of the luminance difference computing process to a process in S4.

The iris authentication apparatus 10 segments the luminance difference image Z handed over from the process in S3 into a predetermined number of block areas (S4). For example, the segmentation can be exemplified such that the luminance difference image Z is segmented by 10 rows arranged in the vertical direction and by 12 columns arranged in the horizontal direction into the 120 rectangular block areas. The segmentation of the luminance difference image Z into the block areas has already been described by using FIG. 7B. The segmented block areas are allocated with, e.g., addresses (allocated with identifying information) “Y (Y=1 . . . 10)” in the vertical direction and addresses (allocated with identifying information) “X (X=1 . . . 12)” in the horizontal direction.

The iris authentication apparatus 10 temporarily stores the block areas segmented from the luminance difference image Z in a predetermined area of the main storage unit 12 by being associated with the identifying information thereof. The iris authentication apparatus 10 hands over the segmented block areas to a process in S5.

In the process of S5, the iris authentication apparatus 10 calculates the average value of the luminance differences per block area segmented from the luminance difference image Z. The average value of the luminance differences is calculated per block area. The iris authentication apparatus 10 totalizes a number of blocks per luminance difference based on the calculated average value of the luminance differences, thereby generating a histogram of the block luminance differences. The generation of the histogram of the block luminance differences has already been explained by using FIG. 8. The iris authentication apparatus 10 hands over the histogram of the block luminance differences to a process in S6.

In the process of S6, the iris authentication apparatus 10 specifies, based on the luminance difference threshold value, the frequency area having the large luminance difference from within the histogram generated in the process of S3. The luminance difference threshold value can be exemplified by, e.g., the luminance difference value “100”. The specifying of the frequency area has been already described by using FIG. 8. The iris authentication apparatus 10 hands over the block area group corresponding to the frequency area exceeding the luminance difference threshold value to a process in S7.

In the process of S7, the iris authentication apparatus 10 specifies the area range becoming the iris authentication processing target based on the block area group handed over from the process in S6. The iris authentication apparatus 10 extracts, as a verifying process application block, the area range becoming the iris authentication processing target area from the luminance difference image Z based on, e.g., the identifying information of the block area group. The iris authentication apparatus 10 hands over the extracted verifying process application block to a process in S9.

In the process of S8, the iris authentication apparatus 10 acquires the video/still images captured by being illuminated with the illumination light having the radiant intensity C for detecting the eyes of the authentication target person. The iris authentication apparatus 10 temporarily stores the video/still images captured by being illuminated with the illumination light having the radiant intensity C in a predetermined area of the main storage unit 12. The iris authentication apparatus 10 hands over the acquired video/still images to a process in S9.

Note that the radiant intensity C for detecting the eyes of the authentication target person and the radiant intensities A, B for obtaining the luminance difference image are in the following relation, in which case the iris authentication apparatus 10 may shift the process in S8 to a process in S9. Herein, a symbol “>” connotes a relative magnitude relation between the radiant intensities, and “≈” connotes that the radiant intensities are substantially equal.

radiant intensity A>radiant intensity C>radiant intensity B

radiant intensity A≈radiant intensity C>radiant intensity B

When a relation such as “radiant intensity A≈radiant intensity C” is established, the radiant intensity in the process of S8 can be of the illumination light having the radiant intensity A used for obtaining the luminance difference image. When registering the iris patterns for the first time, processes in S9-S11 may be executed targeting at the video/still images captured by using the radiant intensity A while skipping the process in S8.

In the process of S9, the iris authentication apparatus 10 detects the eyes of the authentication target person from the video/still images acquired in the process of S8. The eyes of the authentication target person are detected based on the area range of the verifying process application block handed over from the process in S7. The detection of the eyes has been already described by using FIG. 5.

In the process of S10, the iris authentication apparatus 10 extracts the iris patterns as the pattern features of the iris regions from the eyes detected in the process of S9. The iris patterns of the right-and-left eyes of the authentication target person are respectively extracted. The iris authentication apparatus 10 hands over the extracted iris patterns to a process in S11.

In the process of S11, the iris authentication apparatus 10 implements the iris authentication based on the iris patterns, extracted in the process of S10, of the right-and-left eyes, or registers the extracted iris patterns as individual authentication information in the reference iris image DB201. The iris authentication based on the extracted iris patterns, or the registration of the extracted iris patterns in the reference iris image DB201 has already been described by using FIG. 5.

When implementing the iris authentication, the extracted iris patterns are not verified with the iris patterns registered in the reference iris image DB201, in which case the iris authentication apparatus 10 moves to, e.g., the process in S8, and iterates the processes in S9-S11 a predetermined number of times (N) or for a predetermined period.

When registering the iris patterns, the iris regions in the extracted iris patterns are covered with the eyelashes, the eyelids and other equivalent objects, in which case also the iris authentication apparatus 10 moves to, e.g., the process in S8, and iterates the processes in S9-S11 the predetermined number of times (N). This is because the iris patterns, in which the iris regions are covered with the eyelashes, the eyelids and other equivalent objects, are not clear as the individual authentication information to be registered in the reference iris image DB201.

The iris authentication apparatus 10 displays a result of the iris authentication based on the extracted iris patterns on the display device like the LCD 15a. When the iris patterns registered in the reference iris image DB201 are coincident with the iris patterns extracted in the processes of S8-S10, the iris authentication apparatus 10 cancels the set security after implementing the iris authentication. The iris authentication apparatus 10 with the security being canceled accepts the operation input of the user and other equivalent persons. In the iris authentication apparatus 10, the functions of the iris authentication apparatus 10 can be used based on the operation inputs via, e.g., the touch panel, the keyboard 14f and the touch pad 14g.

Whereas when the iris patterns registered in the reference iris image DB201 are not coincident with the iris patterns extracted in the processes of S8-S10, the iris authentication apparatus 10 displays, e.g., a message indicating a failure in authentication on the LCD 15a. The iris authentication apparatus 10 is kept in the locked status without canceling the security being set but does not accept the operation inputs and other equivalent inputs. The iris authentication apparatus 10 failing in the iris authentication is thereby enabled to prevent the leakage of the information and other equivalent situations because of the locked status being kept active.

Herein, the processes in S1-S2 executed by the iris authentication apparatus 10 are one example of “acquiring video/still images becoming an iris authentication processing target.” The CPU 11 or another equivalent processor of the iris authentication apparatus 10 executes the processes in S1-S2 as one example of “acquiring video/still images becoming the iris authentication processing target.”

The processes in S3-S7 executed by the iris authentication apparatus 10 are one example of “specifying an area range with iris authentication processing target images being captured based on a front-and-rear positional relation about a plurality of images within the video/still images”. The CPU 11 or another equivalent processor of the iris authentication apparatus 10 executes the processes in S3-S7 as one example of “specifying an area range with iris authentication processing target images being captured based on a front-and-rear positional relation about a plurality of images within the video/still images”.

The processes in S8-S11 executed by the iris authentication apparatus 10 are one example of “implementing iris authentication by detecting irises in the area range”. The CPU 11 or another equivalent processor of the iris authentication apparatus 10 executes the processes in S8-S11 as one example of “implementing iris authentication by detecting irises in the area range”.

The processes in S3-S7 executed by the iris authentication apparatus 10 are one example of “segmenting video/still images into a plurality of unit areas, and specifying the area range with an image being captured, the image being positioned at front in the front-and-rear positional relation about the plurality of images within the video/still images, based on luminance information per segmented unit area”. The CPU 11 or another equivalent processor of the iris authentication apparatus 10 executes the processes in S3-S7 as one example of “segmenting the video/still images into a plurality of unit areas, and to specify the area range with an image being captured, the image being positioned at front in the front-and-rear positional relation about the plurality of images within the video/still images, based on luminance information per segmented unit area”.

The processes in S1-S2 executed by the iris authentication apparatus 10 are one example of “acquiring first video/still images during an illumination period of illumination light having a first intensity, and acquiring second video/still images during an illumination period of the illumination light having a second intensity”. The CPU 11 or another equivalent processor of the iris authentication apparatus 10 executes the processes in S1-S2 as one example of “acquiring first video/still images during an illumination period of illumination light having a first intensity, and to acquire second video/still images during an illumination period of the illumination light having a second intensity”.

The process in S3 executed by the iris authentication apparatus 10 is one example of “generating the video/still images for specifying the area range, based on a luminance difference between the first video/still images and the second video/still images”. The CPU 11 or another equivalent processor of the iris authentication apparatus 10 executes the process in S3 as one example of “generating the video/still images for specifying the area range, based on a luminance difference between the first video/still images and the second video/still images”.

As described above, the iris authentication apparatus 10 according to the embodiment 1 can acquire the video/still images containing the iris patterns becoming the iris authentication processing target. The iris authentication apparatus 10, when the images of the plurality of candidates exist within the video/still images, can specify the area range in which the image of the candidate becoming the iris authentication processing target is captured, based on the front-and-rear positional relation between the images of the plurality of candidates. The iris authentication apparatus 10 detects the iris patterns based on the area range, and can implement the iris authentication based on the detected iris patterns.

As a result, the iris authentication apparatus 10, even when expanding the image capture range by widening the angle of view of the iris capture camera 14b, can separate other image capture areas excluding the specified target area by way of background processing. The iris authentication apparatus 10 according to the embodiment 1 can implement the iris authentication in the natural operating posture while restraining the image processing throughput from rising. The iris authentication apparatus 10 according to the embodiment 1 can separate other image capture areas excluding the image capture area in which the image of the user is captured within the video/still images by way of the background processing even when the image of the malicious third person is captured behind the user defined as the iris authentication processing target person. The iris authentication apparatus 10 according to the embodiment 1 does not execute the iris authentication process about the image capture area of the malicious third person. The iris authentication apparatus 10 according to the embodiment 1 can prevent the malicious third person from leaking the information.

The iris authentication apparatus 10 according to the embodiment 1 can generate the luminance difference image, based on the luminance difference between the video/still images captured by being illuminated with the illumination light of the different radiant intensities. The iris authentication apparatus 10 can eliminate a uncertain elements for estimating the positional relation, the uncertain elements being exemplified by the ambient illumination component contained in the video/still images, the color components and other equivalent components of the image capture target persons.

The iris authentication apparatus 10 segments the luminance difference image into the predetermined number of block areas, and can thus generate the histogram based on the average value of the luminance differences per block area. The iris authentication apparatus 10 can extract the frequency area having the large luminance difference from the frequency distribution of the histogram. As a consequence, the iris authentication apparatus 10 can estimate the image area positioned at the foreground when captured for the iris authentication as the image capture area of the identified authenticatee.

The iris authentication apparatus 10 can specify the block area corresponding to the frequency area having the large luminance difference in the histogram as the authentication processing target area. The iris authentication apparatus 10 is thereby enabled to implement the iris authentication based on the specified target area, or to register the iris patterns as the authentication information.

### Embodiment 2

When the plurality of candidates is unintentionally captured within the video/still images, it is feasible to identify the image capture area of the person positioned at the foreground when capturing the images by comparing, e.g., magnitude relations between image capture planar dimensions of the unintentionally captured candidates.

The iris authentication apparatus 10 according to an embodiment 2 (which will hereinafter be referred to also as the present embodiment) specifies a face outline of each individual candidate by performing, e.g., an outline cut-out process and other equivalent processes about the video/still images captured by being illuminated with the illumination light of the radiant intensity sufficient for detecting the eyes. The iris authentication apparatus 10 according to the embodiment 2 obtains planar dimensions of specified respective face outlines, and compares the magnitude relations therebetween. The iris authentication apparatus 10 identifies the image capture area having a relatively large face outline as the image capture area of the person positioned at the foreground. The iris authentication apparatus 10 according to the embodiment 2 can specify the area range becoming the iris authentication processing target, based on the magnitude relation between the image capture planar dimensions within the video/still images.

Note that the iris authentication apparatus 10 according to the embodiment 2 is, similarly to the embodiment 1, the portable electronic equipment instanced by the smartphone, the tablet PC and the notebook PC described by using FIGS. 1, 2, 3 and 4. The iris authentication apparatus 10 according to the embodiment 2 has the same hardware configuration as that of the iris authentication apparatus 10 according to the embodiment 1.

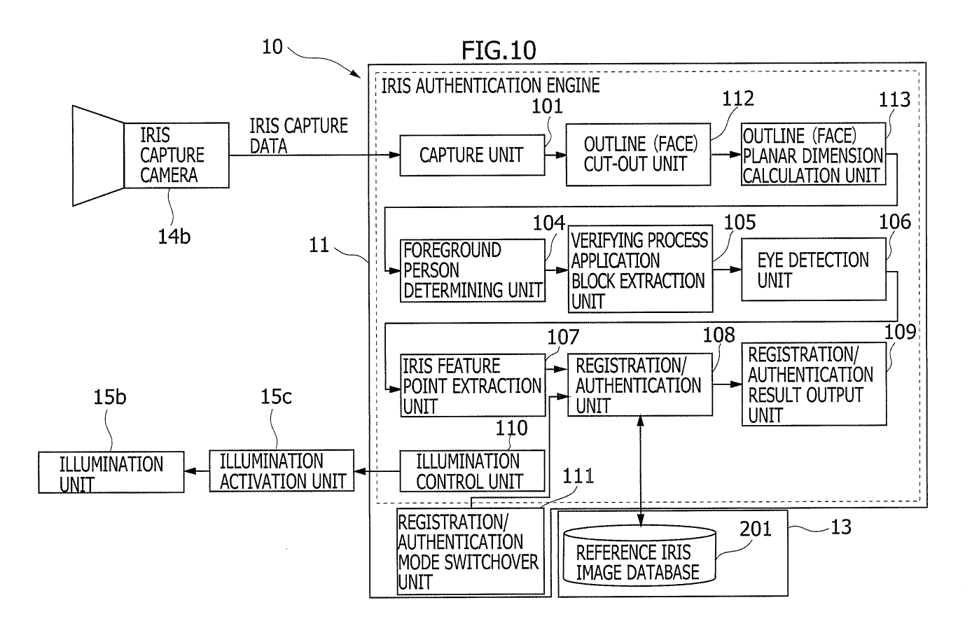

FIG. 10 illustrates an explanatory diagram of processing blocks of the iris authentication apparatus 10 according to the embodiment 2. The iris authentication apparatus 10 according to the embodiment 2 implements an outline (face) cut-out unit 112 in place of the luminance difference computing/block segmenting unit 102 in the embodiment 1. Likewise, the iris authentication apparatus 10 according to the embodiment 2 implements an outline (face) planar dimension calculation unit 113 in place of the histogram processing unit 103 in the embodiment 1.

The iris authentication apparatus 10 according to the embodiment 2 illuminates the illumination light having a radiant intensity D sufficient for detecting the eyes. The illumination control unit 110 controls the illumination activation unit 15c so that, e.g., the illumination unit 15b illuminates the iris pattern capture target person with the illumination light of the radiant intensity D. The illumination control unit 110 controls the illumination activation unit 15c so that an illumination period of the radiant intensity D becomes 33 ms defined as one frame period. An image of the image capture target person illuminated with the illumination light of the radiant intensity D is captured by the iris capture camera 14b.

The capture unit 101 accepts the video/still images (iris capture data) captured by the iris capture camera 14b. The capture unit 101 extracts frames of the video/still images captured by being illuminated with the illumination light of the radiant intensity D from the accepted video/still images. The capture unit 101 temporarily stores, e.g., the extracted frames of the video/still images in a predetermined area of the main storage unit 12, and hands over the video/still images to the outline (face) cut-out unit 112.

The outline (face) cut-out unit 112 executes a process of cutting out face outlines of the images of the plurality of candidates contained in the video/still images by executing a filter process using, e.g., a differential filter and other equivalent filters with respect to the extracted frames of the video/still images. Note that the outline (face) cut-out unit 112 may also cut out the face outlines of the images of the plurality of candidates contained in the video/still images by executing a face recognition process based on features of regions such as the eyes, the nose and the mouth contained in the face. The outline (face) cut-out unit 112 hands over face outline information being cut out of the video/still images to the outline (face) planar dimension calculation unit 113.

The outline (face) planar dimension calculation unit 113 calculates a planar dimension of each of the face outlines, based on the face outline information that is cut out of the video/still images. The outline (face) planar dimension calculation unit 113 calculates a planar dimension of the face outline by, e.g., counting a number of the pixels contained within the cut-out outline. The outline (face) planar dimension calculation unit 113 hands over the calculated planar dimension of the face outline to the foreground person determining unit 104.

The foreground person determining unit 104 compares the planar dimensions of the respective face outlines, which are handed over from the outline (face) planar dimension calculation unit 113, thereby determining magnitude relations between the respective face outlines. The foreground person determining unit 104 determines the image capture area of the face outline having a relatively large planar dimension as the image capture area of the person positioned at the foreground. The foreground person determining unit 104 hands over the image capture area of the face outline having the relatively large planar dimension to the verifying process application block extraction unit 105.

The verifying process application block extraction unit 105 extracts the image capture area contained in the face outline having the relatively large planar dimension as a verifying process application area. The iris authentication apparatus 10 executes the iris authentication process targeted at the area range extracted as the verifying process application area. Similarly to the embodiment 1, the iris authentication process illustrated in FIG. 10 involves implementing the eye detection unit 106, the iris feature point extraction unit 107, the registration/authentication unit 108, and the registration/authentication result output unit 109, which are described by using FIG. 5.

[Processing Flow]

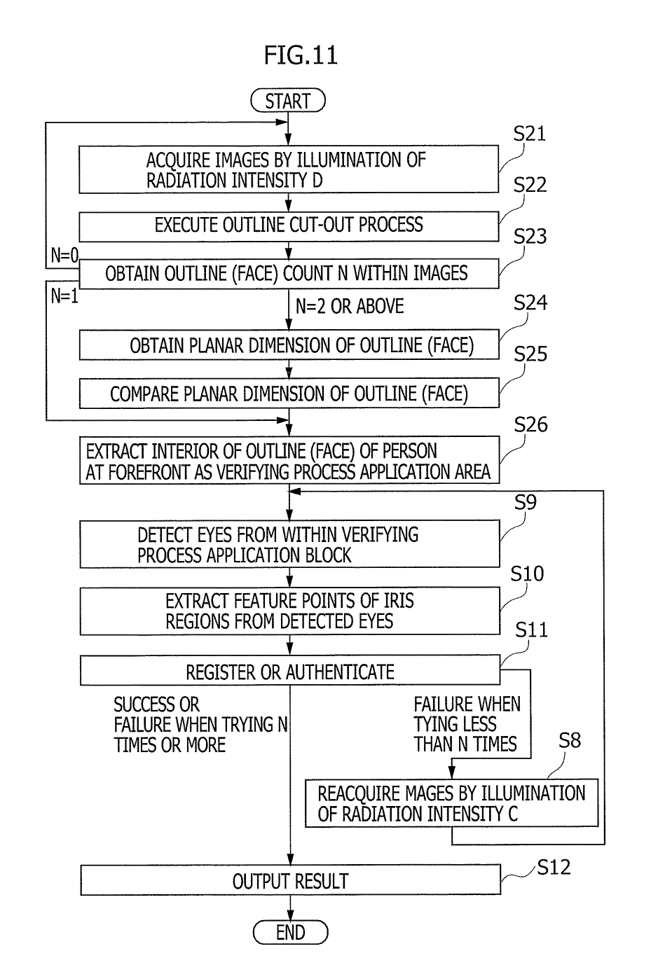

Processes related to the iris authentication by the iris authentication apparatus 10 according to the embodiment 2 will hereinafter be described with reference to a flowchart illustrated in FIG. 11. FIG. 11 illustrates the flowchart of the processes related to the iris authentication by the iris authentication apparatus 10. For example, the processes related to the authentication process in the embodiment 2 involve executing processes in S21 through S26 in place of the processes in S1 through S7 in FIG. 9. In the iris authentication apparatus 10 according to the embodiment 2, the image capture area of the person positioned at the foreground is specified from within the video/still images containing the captured images of the plurality of candidates by executing the processes in S21 through S26.

The CPU 11 reads the OS, the various categories of programs and the various items of data that are stored in the auxiliary storage unit 13 onto the main storage unit 12, and runs these software components, whereby the iris authentication apparatus 10 executes the processes related to the iris authentication illustrated in FIG. 11. The iris authentication apparatus 10 executes the processes related to the iris authentication illustrated in FIG. 11 by referring to the reference iris image DB201 or as a storage location of the data to be managed.

In the flowchart illustrated in FIG. 11, similarly to the embodiment 1, a start of the processes related to the iris authentication by the iris authentication apparatus 10 can be exemplified such as when being triggered by accepting the operation input instruction to implement the iris authentication of the user and other equivalent persons. The operation input instruction to implement the iris authentication of the user and other equivalent persons has already been described by using FIG. 5.

The iris authentication apparatus 10, upon a trigger of the operation input instruction, illuminates the illumination light of the radiant intensity D via the illumination unit 15b. In the iris authentication apparatus 10, the iris capture camera 14b captures the video/still images of the plurality of candidates including the user as the authentication target person, who are illuminated with the illumination light of the radiant intensity D.

The iris authentication apparatus 10 acquires the video/still images captured by being illuminated with the illumination light of, e.g., the radiant intensity D (S21). The iris authentication apparatus 10 hands over the acquired video/still images to a process in S22. The iris authentication apparatus 10 executes the outline cut-out process of cutting out the outlines of the images of the plurality of candidates within the video/still images by executing the filter process about the acquired video/still images (S22). The iris authentication apparatus 10 hands over the video/still images undergoing the outline cut-out process to a process in S23.

The iris authentication apparatus 10 obtains a numerical quantity (N) of the face outline contained in the video/still images based on the video/still images about which the outline cut-out process is executed in S22 (S23). The iris authentication apparatus 10 shifts to a process in S21 when any face outline does not exist in the video/still images about which the outline cut-out process is executed (S23, N=0), and acquires the video/still images captured by being illuminated with the illumination light of the radiant intensity D.

The iris authentication apparatus 10 shifts to a process in S26 when a plurality of face outlines does not exist but one face outline exists within the video/still images about which the outline cut-out process is executed (S23, N=1). In the process of S26, the iris authentication apparatus 10 identifies the image capture area of the face outline within the video/still images about which the outline cut-out process is executed, as an area in which to capture a face image of the person positioned at the foreground. The iris authentication apparatus 10 extracts the image capture area of the face outline within the video/still images as a verifying process application area. The extracted verifying process application area is handed over to the process in S9.

In the process of S23, whereas when the plurality of face outlines exists within the video/still images about which the outline cut-out process is executed (S23, N=2 or more), the iris authentication apparatus 10 shifts to a process in S24. In the process of S24, the iris authentication apparatus 10 obtains an image capture planar dimension per face outline in the plurality of face outlines existing in the video/still images. The iris authentication apparatus 10 hands over information of the image capture planar dimension obtained per face outline to a process in S25.

In the process of S25, the iris authentication apparatus 10 makes comparisons between the respective image capture planar dimensions based on the information of the image capture planar dimension per face outline, which is handed over from the process in S24, thereby determining relative magnitude relations between the image capture planar dimensions. The iris authentication apparatus 10 hands over the image capture area identified as the face outline having the relatively large image capture planar dimension to a process in S26.

In the process of S26, the iris authentication apparatus 10 identifies the image capture area of the face outline handed over from the process in S25 as an area in which to capture the face image of the person positioned at the foreground. The iris authentication apparatus 10 extracts the image capture area of the face outline within the video/still images as the verifying process application area. The extracted verifying process application area is handed over to the process in S9.

In the processes of S9-S12, the processes of S9-S12 described in the flowchart of FIG. 9 are performed. By executing the processes of S9-S12, the iris authentication apparatus 10 carries out the authentication process based on the extracted iris patterns, or registers the iris patterns extracted as the individual authentication information in the reference iris image DB201.

Herein, the process in S11 executed by the iris authentication apparatus 10 according to the embodiment 2 is one example of “acquiring video/still images becoming an iris authentication processing target.” The CPU 11 or another equivalent processor of the iris authentication apparatus 10 according to the embodiment 2 executes the process in S11 as one example of “acquiring the video/still images becoming an iris authentication processing target.”

The processes in S22-S26 executed by the iris authentication apparatus 10 according to the embodiment 2 are one example of “specifying an area range with an iris authentication processing target image being captured based on a front-and-rear positional relation about a plurality of images within the video/still images”. The CPU 11 or another equivalent processor of the iris authentication apparatus 10 according to the embodiment 2 executes the processes in S22-S26 as one example of “specifying an area range with an iris authentication processing target image being captured based on a front-and-rear positional relation about a plurality of images within the video/still images”.

The processes in S22-S26 executed by the iris authentication apparatus 10 according to the embodiment 2 are one example of “specifying an area range with an image being captured, the image being positioned at front in the front-and-rear positional relation about a plurality of images within the video/still images, based on an image capture planar dimension of a predetermined region about the plurality of images within the video/still images”. The CPU 11 or another equivalent processor of the iris authentication apparatus 10 according to the embodiment 2 executes the processes in S22-S26 as one example of “specifying an area range with an image being captured, the image being positioned at front in the front-and-rear positional relation about a plurality of images within the video/still images, based on an image capture planar dimension of a predetermined region about the plurality of images within the video/still images”.

As described above, the iris authentication apparatus 10 according to the embodiment 2 determines the magnitude relation between the image capture planar dimensions (face outline planar dimensions) of the images of the plurality of candidates, which are captured in the video/still images, and is thereby enabled to identify the image capture area of the person positioned at the foreground. The iris authentication apparatus 10 can identify the image capture area having, e.g., the relatively large image capture planar dimension (the face outline planar dimension) as the image capture area of the person positioned at the foreground, and is thereby enabled to specify the area range becoming the iris authentication processing target based on the magnitude relation between the image capture planar dimensions within the video/still images. The iris authentication apparatus 10 according to the embodiment 2 employs the illumination light of the single radiant intensity, and hence it can be expected that the power consumption is restrained to a greater degree than in the case of using the illumination light having the different radiant intensities.

### Modified Embodiment

Such a case is assumed that the image positioned at the foreground does not contain any irises within the video/still images captured by the iris capture camera 14b. For example, this is a case in which an image of an obstacle like a bag and a luggage held in front by the identified authenticatee is captured between the identified authenticatee and the iris capture camera 14b when implementing the iris authentication. In this case, it can be presumed that the image not containing any irises is captured as the image positioned at the foreground.

The iris authentication apparatus 10 according to a modified embodiment, e.g., when the eyes are not detected from the image positioned at the foreground within the video/still images in the process of S9 illustrated in FIGS. 9 and 11, may set the image positioned at the second foreground as the iris authentication processing target. The iris authentication apparatus 10 according to the modified embodiment, when capable of determining that the image positioned at the foreground does not contain the irises, detects the eyes in a way that sets the image positioned at the second foreground as the processing target, and can implement the iris authentication based on the iris patterns contained in the detected eyes. Note that the iris authentication apparatus 10, when determining that the irises are not contained in the foreground image, may prompt the user to be aware of the bag or the luggage held in front by displaying, e.g., a message purporting that the iris patterns are not detected on the display device.

### Embodiment 3

The embodiment 1 and the embodiment 2 have described the processing mode for restraining the increase in image processing throughput when the images of the plurality of persons are captured due to widening the angle of view of the camera and expanding the image capture range. For example, in the case of widening the angle of view of the camera and expanding the image capture range when implementing the iris authentication, the image capture position of the user, whose image is captured in the video/still images, might be biased in the right-and-left directions or the up-and-down directions, depending on a posture of the iris authentication apparatus 10 (a tilt of the camera).

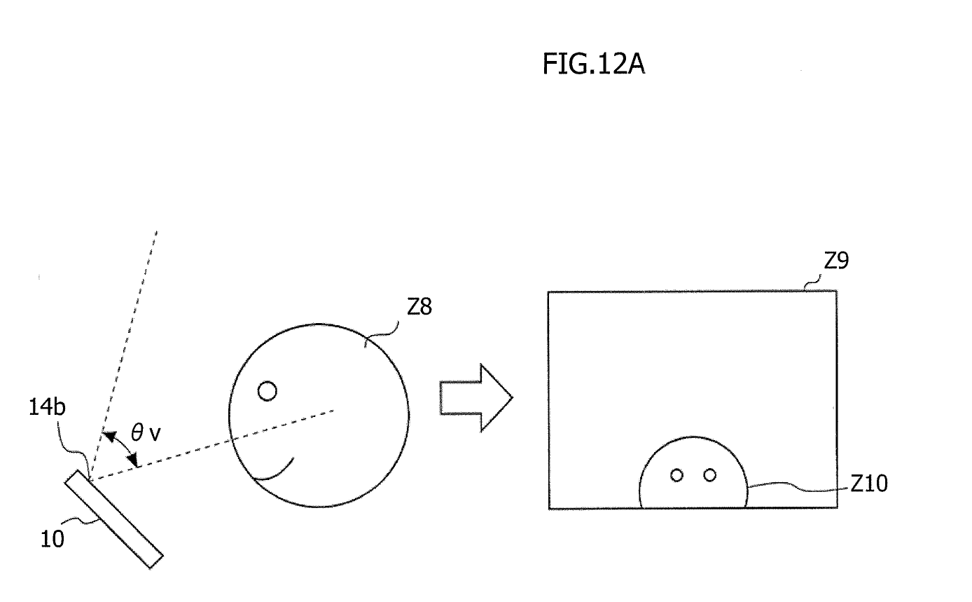

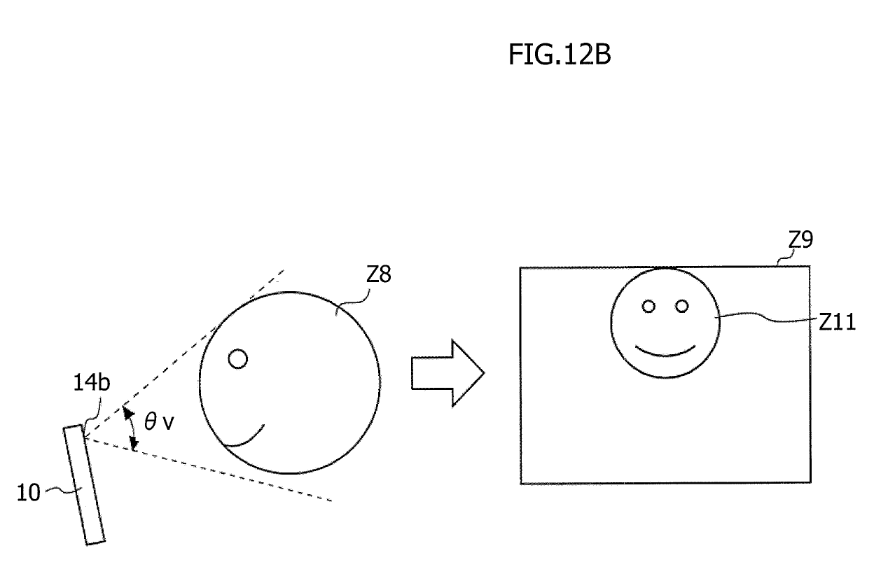

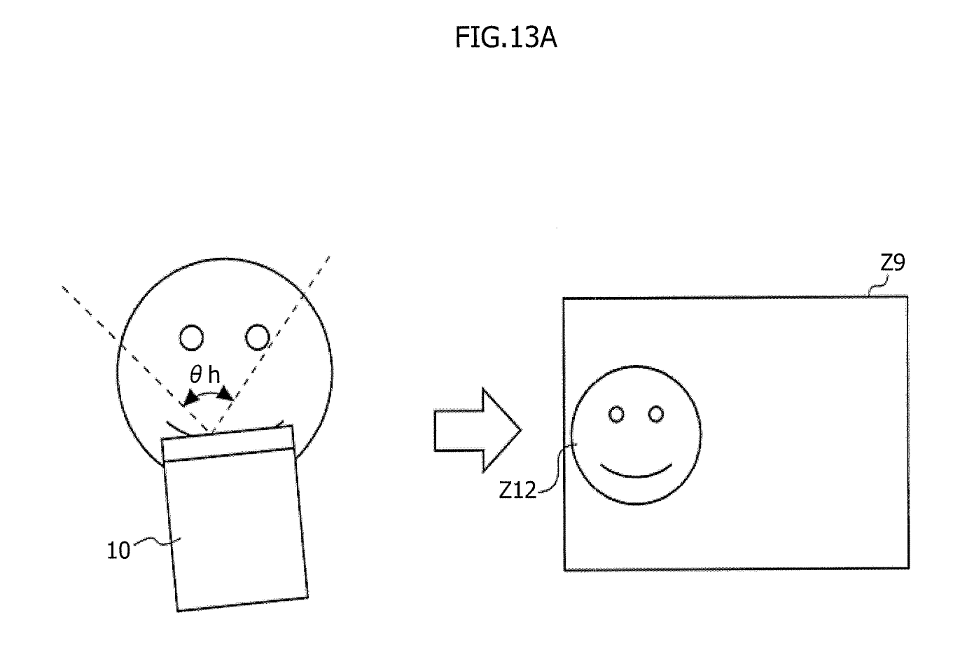

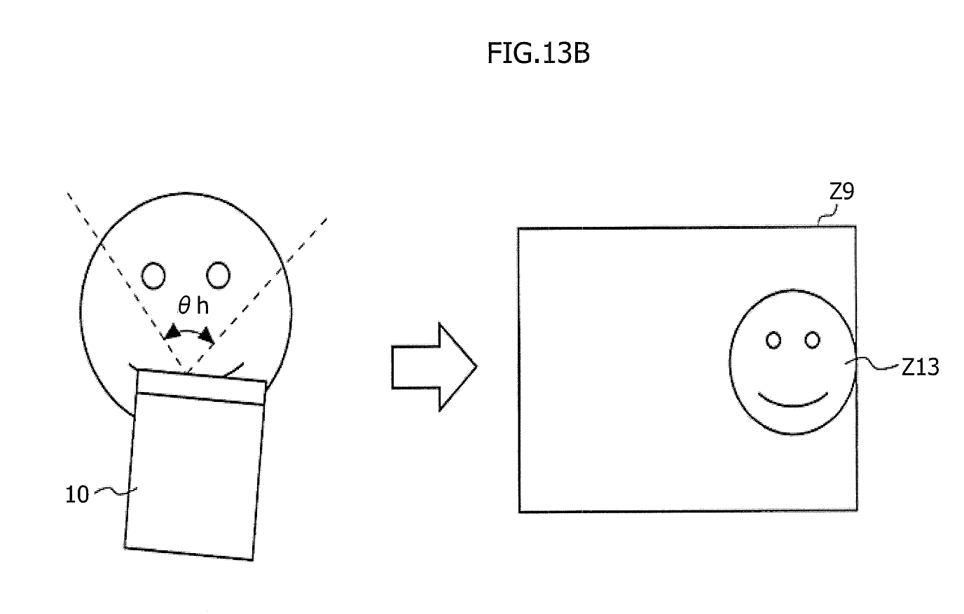

FIGS. 12 and 13 illustrate explanatory diagrams of how the image capture position of the user is biased within the video/still images concomitantly with a change of the posture of the iris authentication apparatus 10. FIGS. 12A-12B are the explanatory diagrams illustrating an example in which when implementing the iris authentication, the posture of the iris authentication apparatus 10 is tilted against a horizontal plane. Likewise, FIGS. 13A-13B are the explanatory diagrams illustrating an example in which when implementing the iris authentication, the posture of the iris authentication apparatus 10 is tilted in the right-and-left directions. Note that the iris capture camera 14b of the iris authentication apparatus 10 is, as described in FIGS. 1 through 3, provided on the external wall surface of the display device line the LCD 15a. An aperture surface of the iris capture camera 14b provided on the external wall surface and the surface of the display device like the LCD 15a are provided in parallel. It therefore follows that the image capture position (the position of the eye) of the user within the video/still images is relatively biased corresponding to the posture of the iris authentication apparatus 10 when implementing the iris authentication.

FIG. 12A is the explanatory diagram illustrating a case in which the image capture surface (the aperture surface) of the iris capture camera 14b is tilted in the horizontal direction relatively to the eye (the iris) of a user z8 conducting the iris authentication. FIG. 12B is the explanatory diagram illustrating a case in which the image capture surface (the aperture surface) of the iris capture camera 14b is tilted in a vertical direction relatively to the eye (the iris) of a user z8 conducting the iris authentication. Note that an angle range θv indicated by a broken line represents a spread of the angle of view of the iris capture camera 14b in the up-and-down directions in FIGS. 12A and 12B.

As depicted in FIG. 12A, when the image capture surface (the aperture surface) of the iris capture camera 14b is relatively tilted in the horizontal direction, it follows that the face image of the user Z8 is captured in the way of using the image capture range in the lower area of the angle of view expressed by the angle range θv. It also follows that an image capture position Z10 of the face of the user Z8 becoming the iris authentication target person is relatively biased downward within video/still images Z9 captured by the iris capture camera 14b.

As illustrated in FIG. 12B, when the image capture surface (the aperture surface) of the iris capture camera 14b is relatively tilted in the vertical direction, it follows that the face image of the user Z8 is captured in the way of using the image capture range in the upper area of the angle of view expressed by the angle range θv. It also follows that the image capture position Z10 of the face of the user Z8 becoming the iris authentication target person is relatively biased upward within the video/still images Z9 captured by the iris capture camera 14b.

When implementing the iris authentication, the posture of the iris authentication apparatus 10 is tilted in the right-and-left directions, in which case also the image capture position of the user Z8 results in being biased within the video/still images. FIG. 13A is the explanatory diagram illustrating a case in which the image capture surface (the aperture surface) of the iris capture camera 14b is tilted rightward relatively to the eye (the iris) of a user z8 conducting the iris authentication. FIG. 13B is the explanatory diagram illustrating a case in which the image capture surface (the aperture surface) of the iris capture camera 14b is tilted leftward relatively to the eye (the iris) of a user z8 conducting the iris authentication. Note that an angle range θh indicated by a broken line represents a spread of the angle of view of the iris capture camera 14b in the right-and-left directions in FIGS. 13A and 13B.

As depicted in FIG. 13A, when the image capture surface (the aperture surface) of the iris capture camera 14b is tilted relatively rightward, it follows that the face image of the user Z8 is captured in the way of using the image capture range in the left area of the angle of view expressed by the angle range θh. It also follows that the image capture position Z10 of the face of the user Z8 becoming the iris authentication target person is relatively biased leftward within the video/still images Z9 captured by the iris capture camera 14b.

As illustrated in FIG. 13B, when the image capture surface (the aperture surface) of the iris capture camera 14b is tilted relatively leftward, it follows that the face image of the user Z8 is captured in the way of using the image capture range in the right area of the angle of view expressed by the angle range θh. It also follows that the image capture position Z10 of the face of the user Z8 becoming the iris authentication target person is relatively biased rightward within the video/still images Z9 captured by the iris capture camera 14b.

When the image capture position of the user, whose image is captured in the video/still images is biased in the right-and-left directions or the up-and-down directions, a scan process (an eye detection process) for specifying an iris authentication processing area is performed also about other areas excluding the image capture position of the user, resulting in a rise in image processing throughput accordingly. The rise in the image processing throughput causes an elongated period of processing time expended for the authentication, resulting in the increase in processing time till obtaining the result of the authentication.

The iris authentication apparatus 10 according to an embodiment 3 (which will hereinafter be described referred to also as the present embodiment) includes the posture detection sensor 14h capable of detecting the posture of the iris authentication apparatus 10. The posture detection sensor 14h can be exemplified by the acceleration sensor and the gyro sensor. The iris authentication apparatus 10 segments the video/still images captured by the iris capture camera 14b into the plurality of block areas. The iris authentication apparatus 10 according to the embodiment 3 estimates which block area in the plurality of block areas the irises (the eyes) of the authentication target person implementing the iris authentication are positioned based on sensor information detected by the posture detection sensor 14h. The iris authentication apparatus 10 executes a detection process (a scan process) of detecting the irises (the eyes) preferentially from the estimated block area in which the irises of the authentication target person are positioned.

The iris authentication apparatus 10 according to the embodiment 3 executes the eye detection process preferentially from the estimated block area in which the irises of the authentication target person are positioned within the video/still images based on the posture information of the iris authentication apparatus 10, which is detected by the posture detection sensor 14h. The iris authentication apparatus 10 according to the embodiment 3 can finish processing other block areas just when detecting the irises in the block area set as the eye detection processing target area. The iris authentication apparatus 10 according to the embodiment 3 does not execute the eye detection process about other block areas not containing the irises within the video/still images, thereby enabling the image processing throughput to be reduced.

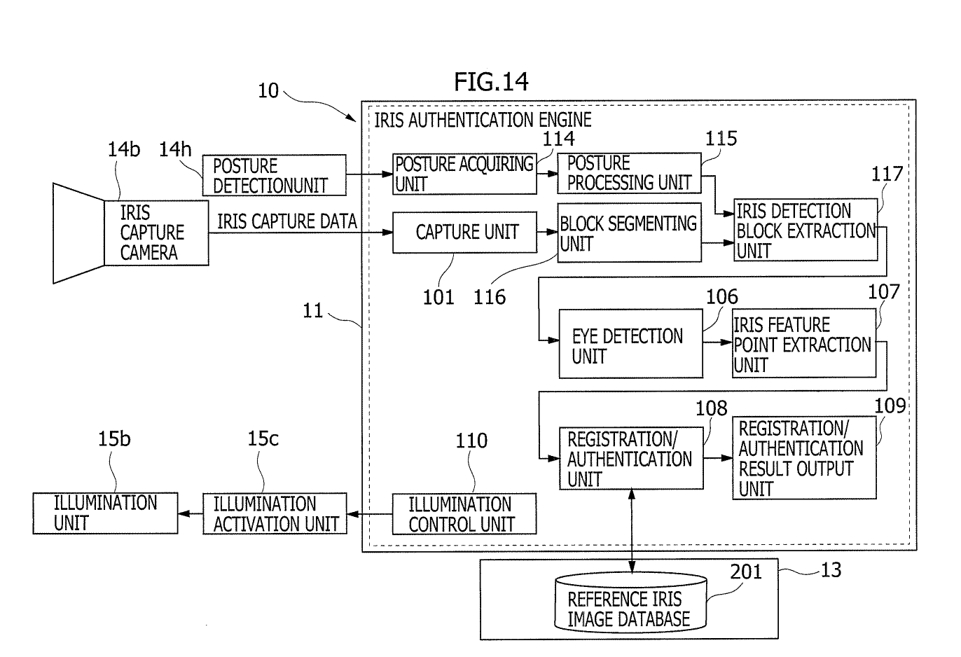

FIG. 14 illustrates an explanatory diagram of processing blocks of the iris authentication apparatus 10 according to the embodiment 3. Note that the iris authentication apparatus 10 according to the embodiment 3 is, similarly to the embodiment 1, the portable electronic equipment instanced by the smartphone, the tablet PC and the notebook PC described by using FIGS. 1, 2, 3 and 4. The iris authentication apparatus 10 according to the embodiment 3 has the same hardware configuration as that of the iris authentication apparatus 10 according to the embodiment 1.

The iris authentication apparatus 10 according to the embodiment 3 illustrated in FIG. 14 includes the posture detection sensor 14h provided in the input unit 14, and provides processing units, i.e., a posture acquiring unit 114, a posture processing unit 115, a block segmenting unit 116, and an iris detection block extraction unit 117.

The posture acquiring unit 114 acquires the sensor information detected by the posture detection sensor 14h upon being triggered by an input of the operation instruction for implementing the iris authentication. The input of the operation instruction for implementing the iris authentication is instanced by the pressing operation on the power button 14c, and the long pressing operation on the operation button 14d when returning to the operation state from the halt state, which are described by using FIG. 5. The sensor information detected by the posture detection sensor 14h is, e.g., detection values of the acceleration sensor, the gyro sensor and other equivalent sensors. The posture acquiring unit 114 temporarily stores the detection values acquired from the posture detection sensor 14h in a predetermined area of the main storage unit 12, and hands over the detection values to the posture processing unit 115.

The posture processing unit 115 specifies the posture of the iris authentication apparatus 10, based on the sensor information (the detection values) handed over from the posture acquiring unit 114. The posture of the iris authentication apparatus 10 can be expressed as, e.g., a posture relative to a basic posture state (a posture basis) of the iris authentication apparatus 10 when implementing the iris authentication.

For example, the posture basis is exemplified by a posture state of the iris authentication apparatus 10 when the user conducts the iris authentication for the iris authentication apparatus 10 placed on the knees in such a posture that the user sits on a chair and other equivalent pieces of furniture, and adjusts the line of sight to the surface of the display device like the LCD 15a.

A vendor (a manufacturer) of the iris authentication apparatus 10 empirically acquires the sensor detected values detected as the sensor information based on, e.g., the posture basis. However, the acquired sensor detection values are acquired as significant data when the image capture position of an examinee on the posture basis is in the vicinity of a center of the video/still images. The vendor of the iris authentication apparatus 10 further acquires the empirical sensor detection values when the iris authentication apparatus 10 is tilted in the right-and-left directions with respect to the vertical direction. The vendor of the iris authentication apparatus 10 still further acquires the empirical sensor detection values when the surface of the display device like the LCD 15a of the iris authentication apparatus 10 is tilted, e.g., in the vertical direction from the horizontal direction. The sensor detection values are, however, acquired on condition that the image capture position of the authenticatee is within the video/still images in an authentication-enabled state (an iris detectable state) also in the case of the iris authentication apparatus 10 being tilted in any direction.

The vendor of the iris authentication apparatus 10 acquires the sensor detection values by performing the same test applied to a plurality of examinees different in terms of physique and gender. The vendor of the iris authentication apparatus 10 executes a statistic process and other equivalent processes about the sensor detection values acquired with respect to the plurality of examinees, and may simply predetermine, from a result of the statistic process, a range of the sensor detection values to be detected as the sensor information, corresponding to a posture basis. Similarly, the vendor of the iris authentication apparatus 10 may simply predetermine, from the result of the statistic process, a deviation range of the sensor detection values such as an upward/downward deviation and a rightward/leftward deviation on the posture basis by being associated with, e.g., the deviation of the image capture position within the video/still images. The vendor of the iris authentication apparatus 10 may also associate the deviation range of the sensor detection values on the posture basis with eight directions, i.e., a “leftward upper” direction, an “upper” direction, a “rightward upper” direction, a “left” direction, a “right” direction, a “leftward lower” direction, a “lower” direction and a “rightward lower” direction with the posture basis being centered.

The iris authentication apparatus 10 can retain, as table information, e.g., the range of the sensor detection values on the posture basis described above and the deviation range of the sensor detection values on the posture basis (or the eight directions with the posture basis being centered) in the auxiliary storage unit 13. The posture processing unit 115 refers to, e.g., the table information retained in the auxiliary storage unit 13, and is thereby enabled to specify the postures relative to the basic posture of the iris authentication apparatus 10 based on the sensor information (the detection values) handed over from the posture acquiring unit 114.

The posture processing unit 115, e.g., when the sensor information handed over from the posture acquiring unit 114 is within the range of the sensor detection values on the posture basis, specifies the posture of the iris authentication apparatus 10 as the “basis”. Likewise, the posture processing unit 115, e.g., when the sensor information handed over from the posture acquiring unit 114 is within the deviation range in the “upper” direction, specifies the posture of the iris authentication apparatus 10 as being “upward biased”.

With respect to other deviation ranges exclusive of the “upper” direction, there are similarly specified the postures relative to the basic posture, such as being “leftward upward biased”, “rightward upward biased”, “leftward biased”, “rightward biased”, “leftward downward biased”, “downward biased” and “rightward downward biased”. The posture processing unit 115 hands over the specified postures of the iris authentication apparatus 10 to the iris detection block extraction unit 117.

Note that in the iris authentication apparatus 10, the range of the sensor detection values on the posture basis and the deviation range of the sensor detection values on the posture basis may also be set through, e.g., the operation input of the user possessing the iris authentication apparatus 10.

It may be sufficient that the iris authentication apparatus 10 presents, e.g., an instruction menu and other equivalent indications for acquiring the sensor detection values on the posture basis described above and the deviation range of the sensor detection values on the posture basis when performing initial settings. The iris authentication apparatus 10 acquires the sensor detection values on the posture basis along the instruction menu and other equivalent indications, the sensor detection values when tilted in the right-and-left directions with respect to the vertical direction, and the sensor detection values when the surface of the display device is tilted in the vertical direction from the horizontal direction. Note that the sensor detection values are acquired on condition that the image capture position of the user on the posture basis is in the vicinity of the center of the video/still images and is within the video/still images in the authentication-enabled state (the iris detectable state) of the image capture position of the user when tilted.

The iris authentication apparatus 10 can set, from the sensor detection values on the posture basis and the sensor detection values when tilted, the range of the sensor detection values on the posture basis and the deviation range of the sensor detection values on the posture basis (or the eight directions with the posture basis being centered). Note that the iris authentication apparatus 10 may correct the table information previously retained in the auxiliary storage unit 13 based on, e.g., the respective sensor detection values acquired when performing the initial settings described above. The iris authentication apparatus 10 enables calibration taking account of operational habits per user possessing the iris authentication apparatus 10.

In the iris authentication apparatus 10 of FIG. 14, for instance, the illumination light of the radiant intensity A sufficient for detecting the eyes is illuminated when implementing the iris authentication. The illumination control unit 110 controls the illumination activation unit 15c so that, e.g., the illumination unit 15b illuminates the iris pattern capture target person with the illumination light of the radiant intensity A. The illumination control unit 110 controls the illumination activation unit 15c so that the illumination period of the illumination light of the radiant intensity A becomes 33 ms as one-frame period. The iris capture camera 14b captures the images of the iris patterns of the authentication target person illuminated with the illumination light of the radiant intensity A.

The capture unit 101 accepts the video/still images (the iris capture data) captured by the iris capture camera 14b. The capture unit 101 extracts the frames of the video/still images captured by being illuminated with the illumination light of the radiant intensity A from the accepted video/still images. The capture unit 101 temporarily stores the extracted frames of the video/still images in a predetermined area of the main storage unit 12, and hands over the extracted frames of the video/still images to the block segmenting unit 116.

The block segmenting unit 116 segments the video/still images handed over from the capture unit 101 into the plurality of block areas. A segmentation count of the block areas can be arbitrarily set corresponding to, e.g., the pixel count of the video/still images, the radiant intensity of the illumination light, the processing performance of the iris authentication apparatus 10, and other equivalent elements.

The segmentation can be exemplified by segmenting the video/still images by 3 in the vertical direction and by 3 in the horizontal direction into 9-segmented rectangular block areas. The segmented block areas are allocated with the identifying information per block area. The block segmenting unit 116 identifies the respective block areas from, e.g., the 2-dimensional address information indicating the addresses in the vertical direction by “Y” and the addresses in the horizontal direction by “X” (X, Y), in which the block area covering the left upper angled portion is used as a reference. The block segmenting unit 116 temporarily stores the segmented block areas and the identifying information (the 2-dimensional address information) for identifying the block areas by being associated with each other in a predetermined area of the main storage unit 12. The block segmenting unit 116 hands over the segmented block areas together with the identifying information to the iris detection block extraction unit 117.

The iris detection block extraction unit 117 estimates which block area within the video/still images segmented into the plurality of block areas the irises (the eyes) of the authentication target person are positioned. The block area covering the positions of the irises is estimated based on the posture, handed over from the posture processing unit 115, relative to the basic posture of the iris authentication apparatus 10.

For example, when the posture, handed over from the posture processing unit 115, of the iris authentication apparatus 10 is the basic posture, the iris detection block extraction unit 117 estimates that the irises are positioned in the block area in the vicinity of the center of the segmented video/still images. The estimated block area in the example of the 9-segmented block areas is, e.g., a block area addressed at (2, 2), which is positioned in the vicinity of the center of the video/still images. Similarly, when the posture, handed over from the posture processing unit 115, of the iris authentication apparatus 10 is “leftward downward biased”, the iris detection block extraction unit 117 estimates that the irises are positioned in the block area in the vicinity of the leftward downward portion of the segmented video/still images. The estimated block area in the example of the 9-segmented block areas is, e.g., a block area addressed at (3, 3), which is positioned in the vicinity of the center of the video/still images.

When executing the eye detection process, the iris detection block extraction unit 117 determines a processing order about the block areas segmented from the video/still images. The processing order is determined based on the posture, handed over from the posture processing unit 115, relative to the basic posture of the iris authentication apparatus 10. Note that the block area estimated to cover the positions of the irises (the eyes) of the authentication target person is first in processing order. The iris detection block extraction unit 117 performs sequencing the eye detection process about the block areas segmented from the video/still images, in which the block area estimated to cover the positions of the irises (the eyes) of the authentication target person is first in processing order.

The posture, handed over from the posture processing unit 115, of the iris authentication apparatus 10 is assumed to be the basic posture. It is also assumed that the video/still images are segmented by 9. The positions of the captured irises (the eyes) of the authentication target person can be estimated to be in the vicinity of the center of the video/still images. Therefore, the iris detection block extraction unit 117 determines the processing order about the block areas existing outside from the block area in the vicinity of the center, in which the block area addressed at (2, 2) is first in processing order.

For example, the iris detection block extraction unit 117 selects the block areas of which the addresses X in the horizontal direction become coincident with that of (the block area to be selected is horizontally adjacent to) the block area being first in processing order such as the addresses (2, 2)→(3, 2)→(1, 2), and thus performs sequencing. Next, the iris detection block extraction unit 117 selects the block area (2, 1) that is adjacent in the vertical direction of the block area being first in processing order. The iris detection block extraction unit 117 selects the block areas that are adjacent in the horizontal direction such as the addresses (2, 1)→(3, 1)→(1, 1), and thus performs sequencing. The iris detection block extraction unit 117 likewise selects the block area (2, 3) that is adjacent in the vertical direction of the block area being first in processing order. The iris detection block extraction unit 117 selects the block areas that are adjacent in the horizontal direction such as the addresses (2, 3)→(1, 3)→(3, 3), and thus performs sequencing.

The iris detection block extraction unit 117 hands over the processing order of the eye detection process, the processing order being such that the block area estimated to cover the positions of the irises (the eyes) of the authentication target person is first in processing order, to the eye detection unit 106. As described by using FIG. 5 and other drawings, the eye detection unit 106 executes the eye detection process targeting at the block areas sequenced by the iris detection block extraction unit 117. The eye detection unit 106 finishes the eye detection process upon detecting the irises (the eyes) of the authentication target person.

Note that the iris detection block extraction unit 117 may be configured to incorporate, into the program, a processing order pattern in which to predetermine the processing order about every block area when the irises (the eyes) of the authentication target person are assumed to be positioned therein. The iris detection block extraction unit 117 can specify the block area estimated to cover the positions of the irises (the eyes) of the authentication target person, also can determine the processing order of the eye detection process with respect to the block areas other than the block area being first in processing order.

The eye detection unit 106 may retain the processing order pattern incorporated into the program. In this case, the iris detection block extraction unit 117 may simply hand over the address (the identifying information) of the block area estimated to cover the positions of the irises (the eyes) of the authentication target person to the eye detection unit 106. The eye detection unit 106 sets the address of the block area handed over from the iris detection block extraction unit 117 as a start position, and is thereby enabled to execute the eye detection process in accordance with the processing order pattern.

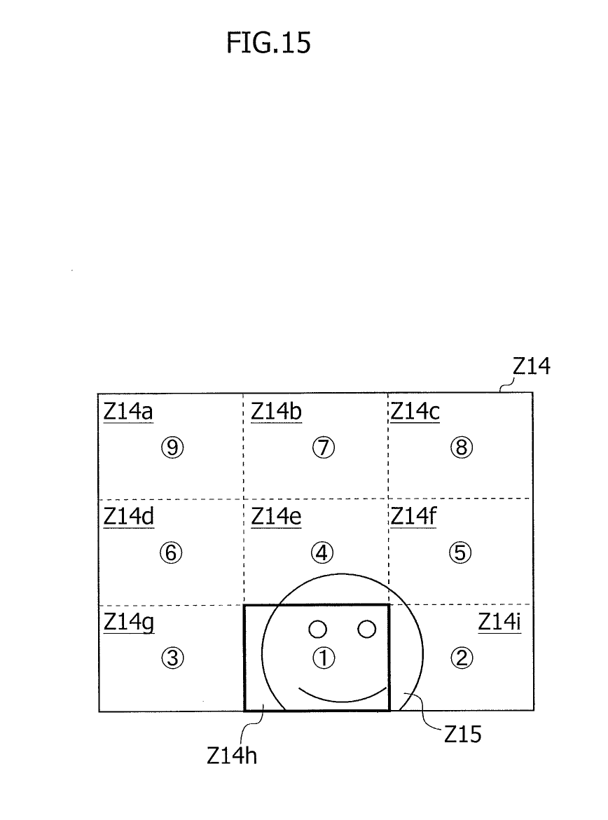

FIG. 15 illustrates an explanatory diagram of the eye detection process according to the embodiment 3. FIG. 15 illustrates one example in which the block segmenting unit 116 segments video/still images Z14 by 9 into block areas Z14a-Z14i. The block areas Z14a-Z14i are respectively allocated with the addresses (X, Y) such as (1, 1), (2, 1), (3, 1), (1, 2), (2, 2), (3, 2), (1, 3), (2, 3) and (3, 3) in sequence. The video/still images Z14 contain a face Z15 of the authentication target person, whose image is captured corresponding to the posture of the iris authentication apparatus 10.

The iris authentication apparatus 10 estimates the block area Z14h, in which the face Z15 containing the irises (the eyes) of the authentication target person is positioned, from the sensor information detected by the posture detection sensor 14h. The iris authentication apparatus 10 determines a processing order of the eye detection process with the block area Z14h being set as a processing start position.

As illustrated in FIG. 15, the block, areas Z14g, Z14i are horizontally adjacent to the block area Z14h in which the face Z15 is positioned. The block area Z14e is vertically adjacent to the block area Z14h. The iris authentication apparatus 10 determines, as indicated by circled numerals “1”-“9”, the processing order of the eye detection process with the block area Z14h being set as the processing start position.

The iris authentication apparatus 10 executes the eye detection process by setting the estimated block area Z14h as a processing target given a highest priority. When the eyes are not detected in the block area Z14h, the eye detection process is executed from the block area Z14i (indicated by the circled numeral “2”) and the block area. Z14g (indicated by the circled numeral “3”) that are adjacent in the horizontal direction, and the block area Z14e (indicated by the circled numeral “4”) that is adjacent in the vertical direction in this sequence. The iris authentication apparatus 10 finishes processing just when detecting the eyes (irises) in the processing target block area, but does not execute the eye detection process about the block areas scheduled from now onward. For example, when the eyes are detected in the block area Z14i indicated by the circled numeral “2”, the block areas indicated by the circled numerals “3”-“9” undergo no processing. The iris authentication apparatus 10 is lessened in terms of the image, processing throughput related to the eye detection process about the block areas indicated by the circled numerals “3”-“9”.

[Processing Flow]

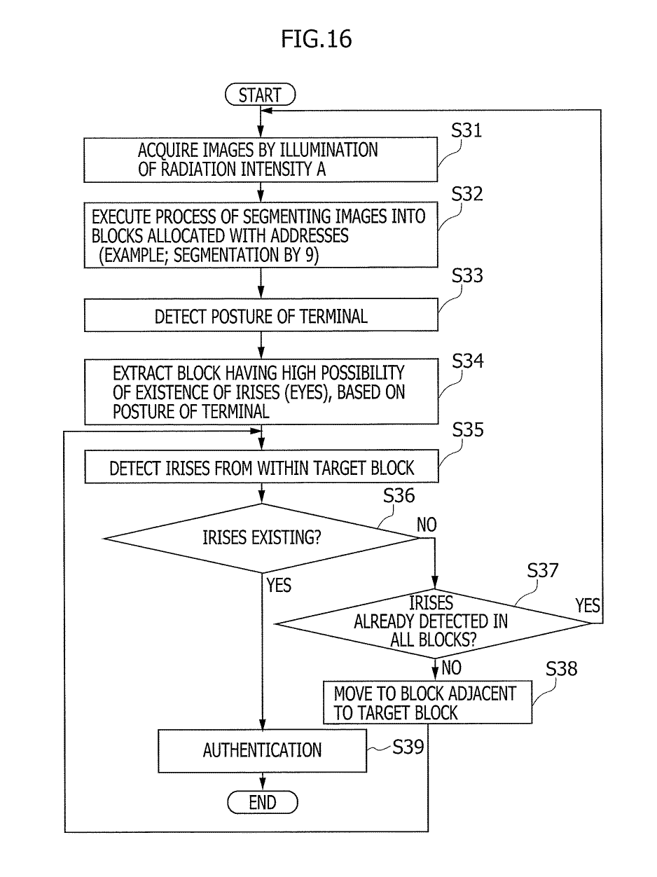

Processes related to the iris authentication by the iris authentication apparatus 10 according to the embodiment 3 will hereinafter be described with reference to a flowchart illustrated in FIG. 16. FIG. 16 illustrates the flowchart of the processes related to the iris authentication by the iris authentication apparatus 10 according to the embodiment 3. The CPU 11 reads the OS, the various categories of programs and the various items of data that are stored in the auxiliary storage unit 13 onto the main storage unit 12, and runs these software components, whereby the iris authentication apparatus 10 executes the processes related to the iris authentication illustrated in FIG. 16. The iris authentication apparatus 10 executes the processes related to the iris authentication illustrated in FIG. 11 by referring to the reference iris image DB201 or as a storage location of the data to be managed.

In the flowchart illustrated in FIG. 16, a start of the processes related to the iris authentication by the iris authentication apparatus 10 can be exemplified such as when being triggered by accepting the operation input instruction to implement the iris authentication of the user and other equivalent persons. The operation input instruction to implement the iris authentication of the user and other equivalent persons has already been described by using FIG. 5.

The iris authentication apparatus 10, upon a trigger of the operation input instruction, illuminates the illumination light of the radiant intensity A via the illumination unit 15b. The iris authentication apparatus 10 acquires the video/still images containing the iris patterns of the authentication target person illuminated with the illumination light of the radiant intensity A (S31). The iris authentication apparatus 10 hands over the acquired video/still images to a process in S32.

The iris authentication apparatus 10 segments the video/still images handed over from the process in S31 by, e.g., 9 into the plurality of block areas (S32). The segmented block areas are allocated with the addresses (allocated with the identifying information) expressed by (X, Y), in which the addresses in the vertical direction are specified by “Y”, and the addresses in the horizontal direction are specified by “X”. The iris authentication apparatus 10 temporarily stores the video/still images segmented into the plurality of block areas and pieces of address information allocated to the respective block areas by being associated with each other in a predetermined area of the main storage unit 12.

In a process of S33, the iris authentication apparatus 10 detects, as the sensor information, the posture state of the iris authentication apparatus 10 when implementing the iris authentication via the posture detection sensor 14h. The iris authentication apparatus 10 temporarily stores the detected sensor information in a predetermined area of the main storage unit 12, and hands over the sensor information to a process in S34.

In a process of S34, the iris authentication apparatus 10 specifies the posture state of the iris authentication apparatus 10, based on the sensor information detected in the process of S33. The posture state of the iris authentication apparatus 10 is expressed as a posture state relative to, e.g., the posture basis. The posture basis has already been described by using FIG. 14 and other drawings.

The iris authentication apparatus 10 estimates, from the specified posture state, which block area the irises (the eyes) of the authentication target person are positioned within the video/still images segmented into the plurality of block areas. The iris authentication apparatus 10 performs sequencing the eye detection process about other block areas adjacent to the block area estimated to cover the positions of the irises (the eyes) of the authentication target person. The iris authentication apparatus 10 extracts the address information allocated to the block area estimated to cover the positions of the irises (the eyes) of the authentication target person. The iris authentication apparatus 10 extracts the pieces of address information of the block areas being sequenced inclusively of other block areas adjacent to the estimated block area in an execution order of the eye detection process. The iris authentication apparatus 10 aligns the extracted pieces of address information of the block areas according to the eye detection processing order, and hands over the aligned pieces of address information to a process in S35.

In the process of S35, the iris authentication apparatus 10 executes the eye detection process by setting the block area estimated to cover the positions of the irises (the eyes) of the authentication target person as the target block area given the highest priority. The iris authentication apparatus 10 determines in the process of S35 whether the eyes (the irises) of the authentication target person are detected in the processing target block area (S36).

The iris authentication apparatus 10 shifts to a process in S39 when the eyes (the irises) of the authentication target person are detected in the processing target block area (S36, YES). Whereas when the eyes (the irises) of the authentication target person are not detected in the processing target block area (S36, NO), the iris authentication apparatus 10 diverts to a process in S37.

In the process of S37, the iris authentication apparatus 10 determines whether the eye detection process is executed about all the block areas segmented in the process of S32. The iris authentication apparatus 10 loops back to the process in S31 when the eye detection process is executed about all the segmented block areas (S37, YES). This is because the iris authentication apparatus 10 is to execute the processes in FIG. 16 by targeting at the new video/still images.

Whereas when the eye detection process is not executed about all the segmented block areas (S37, NO), the iris authentication apparatus 10 shifts to a process of S38. In the process of S38, the iris authentication apparatus 10 moves the eye detection processing target block area to another adjacent block area according to the address information of the block areas being sequenced in the process of S34. After the process in S38, the iris authentication apparatus 10 loops back to the process in S35.

In the process of S39, the iris authentication apparatus 10 executes the iris authentication process based on the iris patterns of the eyes detected in the eye detection process. The iris authentication apparatus 10 implements the iris authentication based on the iris patterns of the eyes detected in the eye detection process by executing the processes in, e.g., S9-S12 illustrated in FIG. 11.

The iris authentication apparatus 10 displays a result of the iris authentication using the extracted iris patterns on the display device like the LCD 15a. The iris authentication apparatus 10, when the iris patterns registered in the reference iris image DB201 are coincident with the extracted iris patterns, cancels the set security after the iris authentication. The iris authentication apparatus 10 with the security being canceled accepts the operation input of the user and other equivalent persons. In the iris authentication apparatus 10, it is feasible to utilize the functions of the iris authentication apparatus 10 based on the operation inputs via, e.g., the touch panel, the keyboard 14f and the touch pad 14g.

Whereas when the iris patterns registered in the reference iris image DB201 are not coincident with the extracted iris patterns, the iris authentication apparatus 10 displays, e.g., a message saying a failure in authentication on the LCD 15a. The iris authentication apparatus 10 keeps the locked state without canceling the set security, but does not accept the operation input and other equivalent inputs. The iris authentication apparatus 10 failing in the iris authentication is thereby enabled to prevent the leakage of the information and other equivalent situations because of the locked status being kept active. After the process in S39, the iris authentication apparatus 10 finishes the processes in FIG. 16.

Herein, the process in S31 executed by the iris authentication apparatus 10 is one example of “acquiring video/still images becoming an iris authentication processing target”. The CPU 11 or another equivalent processor of the iris authentication apparatus 10 executes the process in S33 as one example of “acquiring video/still images becoming an iris authentication processing target.”

The process in S33 executed by the iris authentication apparatus 10 is one example of “detecting a posture of a self apparatus when executing an iris authentication”. The CPU 11 or another equivalent processor of the iris authentication apparatus 10 executes the process in S33 as one example of “detecting a posture of a self apparatus when executing an iris authentication”.

The processes in S32, S34 executed by the iris authentication apparatus 10 are one example of “segmenting the video/still images into a plurality of unit areas; specifying a first unit area estimated to cover existence of an iris authentication processing target image, based on the detected posture”. The CPU 11 or another equivalent processor of the iris authentication apparatus 10 executes the processes in S32, S34 as one example of “segmenting the video/still images into a plurality of unit areas; specifying a first unit area estimated to cover existence of an iris authentication processing target image, based on the detected posture”.

The processes in S35-S39 executed by the iris authentication apparatus 10 are one example of “implementing iris authentication by detecting an iris with the first unit area being set a processing target area given a top preference”. The CPU 11 or another equivalent processor of the iris authentication apparatus 10 executes the processes in S35-S39 as one example of “implementing iris authentication by detecting an iris with the first unit area being set a processing target area given a top preference”.

### Modified Example

When performing the segmentation in the process of S32, the video/still images may also be segmented into the plurality of block areas so that edge portions of the adjacent block areas are overlapped with each other. For example, in FIG. 15, the video/still images maybe segmented in a way that overlaps a right edge portion of the block area Z14h with a left edge portion of the adjacent block area Z14i. The segmentation to overlap the edge portions of the adjacent block areas with each other enables the iris authentication apparatus 10 to detect the eye (the iris) positioned at a boundary between the block areas without overlooking the eye.

As discussed above, the iris authentication apparatus 10 according to the embodiment 3 can detect the posture state of the iris authentication apparatus 10 when implementing the iris authentication. The iris authentication apparatus 10 can estimate the block area in which the irises of the authentication target person are positioned from within the plurality of block areas, based on the detected posture state. The iris authentication apparatus 10 can execute the process of detecting the irises (the eyes) sequentially from the block area estimated to cover the positions of the irises of the authentication target person and from other block areas adjacent to the estimated block area. The iris authentication apparatus 10 can finish the eye detection process about other block areas just when detecting the irises in the target block area. As a result, the iris authentication apparatus 10 according to the embodiment 3 can reduce the image processing throughput about other block areas not encompassing the irises with the video/still images.

The iris authentication apparatus 10 described above enables the iris authentication to be implemented in the natural operating posture, while restraining the rise in image processing throughput.

<Non-Transitory Computer Readable Recording Medium>

A program making a computer, other machines and apparatuses (which will hereinafter be referred to as the computer and other equivalent apparatuses) attain any one of the functions, can be recorded on a non-transitory recording medium readable by the computer and other equivalent apparatuses. The computer and other equivalent apparatuses are made to read and run the program on this non-transitory recording medium, whereby the function thereof can be provided.

Herein, the non-transitory recording medium readable by the computer and other equivalent apparatuses connotes a non-transitory recording medium capable of accumulating information instanced by data, programs and other equivalent information electrically, magnetically, optically, mechanically or by chemical action, which can be read from the computer and other equivalent apparatuses. Among these non-transitory recording mediums, the mediums removable from the computer and other equivalent apparatuses are exemplified by a flexible disc, a magneto-optic disc, a CD-ROM, a CD-R/W, a DVD, a Blu-ray disc, a DAT, an 8 mm tape, and a memory card like a flash memory. A hard disc, a ROM and other equivalent recording mediums are given as the non-transitory recording mediums fixed within the computer and other equivalent apparatuses.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An iris authentication apparatus comprising:
a memory; and
a processor coupled to the memory and the processor configured to perform:
acquiring video/still images becoming an iris authentication processing target;
specifying an area range with an iris authentication processing target image being captured based on a front-and-rear positional relation about a plurality of images within the video/still images; and
implementing iris authentication by detecting irises in the area range.

2. The iris authentication apparatus according to claim 1, wherein the specifying includes segmenting the video/still images into a plurality of unit areas, and specifying the area range with an image being captured, the image being positioned at front in the front-and-rear positional relation about the plurality of images within the video/still images, based on luminance information per segmented unit area.

3. The iris authentication apparatus according to claim 1, further comprising an illumination unit configured to illuminate illumination light having a first intensity and the illumination light having a second intensity different from the first intensity,
wherein the acquiring includes acquires first video/still images during an illumination period of the illumination light having the first intensity, and acquires second video/still images during an illumination period of the illumination light having the second intensity, and
the specifying includes generating the video/still images for specifying the area range, based on a luminance difference between the first video/still images and the second video/still images.

4. The iris authentication apparatus according to claim 1, wherein the specifying includes specifying the area range with the image being captured, the image being positioned at front in the front-and-rear positional relation about the plurality of images within the video/still images, based on an image capture planar dimension of a predetermined region about the plurality of images within the video/still images.

5. An iris authentication apparatus comprising:
a memory; and
a processor coupled to the memory and the processor configured to perform:
acquiring video/still images becoming an iris authentication processing target;
detecting a posture of a self apparatus when executing an iris authentication;
segmenting the video/still images into a plurality of unit areas;
specifying a first unit area estimated to cover existence of an iris authentication processing target image, based on the detected posture; and
implementing iris authentication by executing a process of detecting an iris with the first unit area being set a processing target area given a top preference.

6. The iris authentication apparatus according to claim 5, wherein the segmenting includes determining a processing order of the process of detecting the iris about other unit areas excluding the first unit area, based on the detected posture.

7. A non-transitory computer-readable recording medium having stored therein an iris authentication program of an information processing apparatus including a processor, the iris authentication program cause the processor to perform:
acquiring video/still images becoming an iris authentication processing target;
specifying an area range with an iris authentication processing target image being captured based on a front-and-rear positional relation about a plurality of images within the video/still images; and
implementing iris authentication by detecting an iris in the area range.

8. The non-transitory computer-readable recording medium having stored therein an iris authentication program according to claim 7, wherein the specifying includes segmenting the video/still images into a plurality of unit areas, and specifying the area range with an image being captured, the image being positioned at front in the front-and-rear positional relation about the plurality of images within the video/still images, based on luminance information per segmented unit area.

9. The non-transitory computer-readable recording medium having stored therein an iris authentication program according to claim 7, wherein the computer comprises an illumination unit configured to illuminate illumination light having a first intensity and the illumination light having a second intensity different from the first intensity,
the acquiring includes acquiring first video/still images during an illumination period of the illumination light having the first intensity, and acquiring second video/still images during an illumination period of the illumination light having the second intensity, and
the specifying includes generating the video/still images for specifying the area range, based on a luminance difference between the first video/still images and the second video/still images.

10. The non-transitory computer-readable recording medium having stored therein an iris authentication program according to claim 7, wherein the specifying includes specifying the area range with the image being captured, the image being positioned at front in the front-and-rear positional relation about the plurality of images within the video/still images, based on an image capture planar dimension of a predetermined region about the plurality of images within the video/still images.
